(19) United States
(12) Patent Application Publication
(10) Pub. No.: US 2024/0215570 A1
(43) Pub. Date: Jul. 4, 2024

(54) USE OF LIPID BINDING PROTEIN-BASED COMPLEXES IN ORGAN PRESERVATION SOLUTIONS

(71) Applicant: Abionyx Pharma SA, Balma (FR)

(72) Inventors: Cyrille TUPIN, Castelmaurou (FR); Ronald BARBARAS, Seilh (FR); Loreto GESUALDO, Altamura (IT); Rossana FRANZIN, Bitonto (IT); Alessandra STASI, Bisceglie (IT)

(73) Assignee: Abionyx Pharma SA, Balma (FR)

(21) Appl. No.: 18/554,688

(22) PCT Filed: Apr. 14, 2022
(86) PCT No.: PCT/IB2022/000227

§ 371 Date: Oct. 10, 2023

Related U.S. Application Data
(60) Provisional application No. 63/175,330, filed on Apr. 15, 2021.

(51) Int. Cl. A01N 1/02

(52) U.S. Cl. CPC A01N 1/0226; A01N 1/0247; A01N 1/0284

(57) ABSTRACT

Lipid binding protein-based complexes for use in an organ preservation solution, organ preservation solutions comprising lipid binding protein-based complexes, kits for making organ preservation solutions, processes for preserving organs using the organ preservation solutions, organs preserved thereby, systems for preserving organs comprising the organ preservation solutions, and methods for transplanting organs obtained by the organ preservation processes.

### 1. CROSS-REFERENCE TO RELATED APPLICATIONS

This application claims the priority benefit of U.S. provisional application No. 63/175,330, filed Apr. 15, 2021, the contents of which are incorporated herein in their entireties by reference thereto.

### 2. SEQUENCE LISTING

The instant application contains a Sequence Listing which has been submitted electronically in ASCII format and is hereby incorporated by reference in its entirety. Said ASCII copy, created on Apr. 11, 2022 is named CRN-043WO_SL.txt and is 4,326 bytes in size.

### 3. BACKGROUND

Renal transplantation is a lifesaving treatment for patients for end-stage renal disease (ESRD). The latter represent about the 10% of the worldwide population of those suffering from chronic kidney disease and are projected to rise to 7.640 million people by 2030 (Liyanage et al., 2015, Lancet, 385(9981): 1975-82; Levin et al., 2017, Lancet, 390(10105): 1888-917). However, despite the fact that renal transplantation can dramatically impact the quality of life and save expensive dialysis costs there are still unsolved problems. Firstly, there are insufficient numbers of donor kidneys available and more than 20 people die every day while waiting for a transplant organ. This shortage of organs forces transplant professionals to accept “marginal” organs from cardiac death or older (age ≥60) donors namely the DCD (Donation after Circulatory Death) and ECD (Expanded Criteria Donors) donors. However, the use of these kidneys correlates with a poorer survival, incidence of rejection and Delay Graft Function (DGF). Secondly, regardless of donor used, storage, transport and the transplant surgery itself, with the unavoidable risk of Ischemia/Reperfusion Injury (IRI) can massively affect organ quality. In addition to kidneys, other organs such as hearts and lungs are also prone to IRI (Fernandez et al., 2020, Int. J. Mol. Sci. 21:8549).

Organ preservation solutions have been developed to diminish the injury caused to the donor organ during storage and transportation and to improve graft survival following organ transplantation. The use these organ preservation solutions with machine perfusion has demonstrated superior outcomes in early allograft dysfunction compared to static Cold Storage (CS). Recent studies have shown that ex vivo normothermic machine perfusion (NMP) led to lower rates of DGF, improved renal metabolism and reduced renal IRI (Kataria et al., 2019, Curr Opin Organ Transplant. 24(4):378-384). NMP appears to be superior as a preservation method when compared to CS (Hosgood et al., 2018, Br J Surg 105(4), 388-394) thus potentially increasing the donor pool by improving the outcome of transplantation of grafts from Expanded Criteria Donation (ECD) as well as from Donation after Circulatory Death (DCD). Kidney grafts preserved by NMP sustain less ischemic reperfusion injury after warm ischemia (Kaths et al., 2017, Transplantation 101(4), 754-763) even when compared to immediately transplanted non-stored kidneys. Besides allowing for retention of function, NMP can be used to keep organs in a controlled state allowing close observation and viability assessment enabling successful transplantation (Hamar et al., 2018, Transplantation 102(8), 1262-1270). Although various organ preservation solutions have been developed to diminish donor organ injury prior to transplantation, organ injury prior to transplantation remains a problem.

Therefore, there is an urgent need to develop new approaches in organ preservation.

### 4. SUMMARY

The disclosure provides, in various aspects, lipid binding protein-based complexes for use in organ preservation solutions, organ preservation solutions comprising a lipid binding protein-based complex, kits comprising a lipid binding protein-based complex and one or more components of an organ preservation solution, processes for preparing an organ preservation solution comprising a lipid binding protein-based complex, systems comprising an organ preservation solution of the disclosure and a perfusion machine and/or organ, processes for ex-vivo organ preservation, organs obtained by organ preservation processes of the disclosure, and methods of transplanting organs of the disclosure into subjects in need thereof. The organ preservation solutions described herein can be used to preserve both organs and tissues (e.g., corneas). Thus, in various aspects, the disclosure provides systems comprising an organ preservation solution of the disclosure and a perfusion machine and/or tissue, processes for ex-vivo tissue preservation, tissues obtained by tissue preservation processes of the disclosure, and methods of transplanting tissues of the disclosure in subjects in need thereof.

Several studies have demonstrated that high-density lipoprotein (HDL) particles, the central transporter of cholesterol from peripheral tissues to liver, are involved in important cellular protective functions. HDL complexes exert anti-inflammatory, anti-atherogenic, and anti-fibrotic functions, prevent LDL oxidation by ROS with vasoprotective effect, and inhibit coagulation and platelet aggregation. HDL particles can carry antioxidant enzymes (e.g., serum paraoxonase/arylesterase 1 (PON1), lecithin-cholesterol acyltransferase LCAT and lipoprotein-associated phospholipase A2 LpPLA2) and are able to prevent lipid peroxidation (Rysz et al., 2020, Int J Mol Sci. 21(2):601)

HDL or ApoA-I administration in rat models of renal IRI was shown to significantly improve renal function, reduce renal and tubular dysfunction and decrease the numbers of polymorphonuclear leukocytes (PMN) infiltrating into renal tissues during reperfusion, which was reflected by an attenuation of the increase in renal myeloperoxidase activity caused by I/R (Kaths et al., 2017, Transplantation 101(4), 754-763; Rysz et al., 2020, Int J Mol Sci. 21(2):601). Furthermore, HDL markedly reduced expression of the adhesion molecules, intercellular adhesion molecule-1 (ICAM-1), and P-selectin during reperfusion (Thiemermann et al., 2003, J Am Soc Nephrol. 14(7):1833-1843; Lee et al., 2005, Atherosclerosis. 183(2):251-258) In particular, the administration of ApoA-I significantly reduced serum creatinine levels, serum TNF-alpha and IL-1beta levels as well as tissue myeloperoxidase (MPO) activity, compared with IRI controls. Moreover, ApoA-I treatment suppresses the expression of intercellular adhesion molecules-1 (ICAM-1) and P-selectin on endothelium, thus diminishing neutrophil adherence and the subsequent tissue injury (Shi., 2008, J Biomed Sci. 15(5):577-583).

Considering the protective functions of HDL and its ability to reduce systemic inflammation and oxidative stress, to preserve renal function and counteract endothelial dysfunction and tubular impairment, it is believed, without being bound by theory, that lipid binding protein-based complexes, such as the HDL mimetic drug CER-001, can advantageously be used ex vivo in organ preservation solutions. Again without being bound by theory, it is believed that ex vivo use of lipid binding protein-based complexes such as CER-001 can protect graft endothelial cells by reducing adhesion molecules that control the recruitment of potentially harmful pro-inflammatory mononuclear cells into the graft and improve renal function, thus leading to a decreased risk of DGF and acute rejection of donor kidneys. It is further believed that lipid binding protein-based complexes, such as the HDL mimetic drug CER-001, can similarly protect other organs, for example, heart and lung, during storage and transportation.

Accordingly, in one aspect, the present disclosure provides lipid binding protein-based complexes (e.g., CER-001) for use in organ preservation solutions. Exemplary features of lipid binding protein-based complexes are described in Section 6.1 and specific embodiments 1 to 21 and 24 to 43, infra.

In another aspect, the present disclosure provides organ preservation solutions comprising a lipid binding protein-based complex (e.g., CER-001). Exemplary features of organ preservation solutions are described in Section 6.2 and specific embodiments 22 to 63, infra.

In another aspect, the present disclosure provides kits comprising a lipid binding protein-based complex and one or more components of an organ preservation solution. Exemplary features of kits are described in Section 6.3 and specific embodiments 64 to 78, infra.

In certain aspects, the disclosure provides processes for preparing an organ preservation solution and organ preservation solutions prepared thereby. Exemplary features of processes for preparing organ preservation solutions of the disclosure and organ preservation solutions prepared by such processes are described in Section 6.2 and specific embodiments 79 to 95, infra.

In certain aspects, the disclosure provides systems comprising an organ preservation solution, a perfusion machine and/or an organ. In certain aspects, the disclosure provides systems comprising an organ preservation solution and a tissue. Exemplary features of systems of the disclosure are described in Section 6.3 and specific embodiments 96 to 112, infra.

In certain aspects, the disclosure provides processes for ex-vivo organ preservation and organs obtained thereby. In certain aspects, the disclosure provides processes for ex-vivo tissue preservation and tissues obtained thereby. Exemplary features of ex-vivo organ and tissue preservation processes and organs and tissues obtained thereby are described in Section 6.4 and specific embodiments 113 to 154 and 156 to 179, infra.

In further aspects, the disclosure provides methods for transplanting an organ into a subject in need thereof. In further aspects, the disclosure provides methods for transplanting a tissue to a subject in need thereof. Exemplary features of transplantation methods of the disclosure are described in Section 6.4 and numbered embodiments 155 and 180-186, infra.

### 5. BRIEF DESCRIPTION OF THE FIGURES

FIGS. 1A-1B: vascular resistance (FIG. 1A) and flow (FIG. 1B) for pig kidneys HMP-perfused for four hours with PumpProtect® solution (circles) or PumpProtect® solution supplemented with CER-001 (squares) (Example 4). n=5 for each group.

FIGS. 2A-2E: histological analysis performed by Periodic acid-Schiff (PAS) staining (FIG. 2A); tubular injury scores (FIG. 2B); levels of MCP-1 in perfusate (FIG. 2C); levels of TNF-α in perfusate (FIG. 2D); and levels of aspartate aminotransferase in paerfusate (FIG. 2E) from pig kidneys HMP-perfused with PumpProtect® solution (control) or PumpProtect® solution supplemented with CER-001 (CER-001) (Example 4). In FIGS. 2C-2E, control data is shown with circles; CER-001 data is shown with squares.

FIGS. 3A-3C: CCL2 (MCP-1) (FIG. 3A), IL-6 (FIG. 3B) and ET-1 (FIG. 3C) gene expression in kidneys perfused with PumpProtect® solution (control) or PumpProtect® solution supplemented with CER-001 (CER-001), or maintained in static cold storage (SCS) (Example 4). Results are means±SD, n=5. * p<0.05 In FIGS. 3B-3C, SCS data is shown with triangles, control data is shown with circles, and CER-001 data is shown with squares.

FIG. 4: FACS analysis showing Ser 1177-eNOS phosphorylation in endothelial cells (Example 5).

FIGS. 5A-5E: Renal perfusion parameters of kidneys NMP-perfused with a conventional preservation solution (control) or conventional preservation solution supplemented with CER-001 (Example 6). FIGS. 5A-5C: vascular resistance; FIG. 5D: flow;

FIG. 5E: urine output. In FIGS. 5A-5E, control data is shown with circles and CER-001 data is shown with squares.

### 6. DETAILED DESCRIPTION

The disclosure provides, in various aspects, lipid binding protein-based complexes for use in organ preservation solutions, organ preservation solutions comprising a lipid binding protein-based complex, kits comprising a lipid binding protein-based complex and one or more components of an organ preservation solution, processes for preparing an organ preservation solution comprising a lipid binding protein-based complex, systems comprising an organ preservation solution of the disclosure and a perfusion machine and/or organ, processes for ex-vivo organ preservation, organs obtained by a process of the disclosure, and methods of transplanting organs of the disclosure into subjects in need thereof. The organ preservation solutions of the disclosure can be used to preserve both organs and tissues (for example eye (e.g., cornea or sclera), skin, fat, muscle, bone, cartilage, fetal thymus, and nerve tissue). Thus, the disclosure further provides systems comprising an organ preservation solution of the disclosure and a tissue, processes for ex-vivo tissue preservation, tissues obtained by a process of the disclosure, and methods of transplanting tissues of the disclosure to subjects in need thereof.

Exemplary features of lipid binding protein-based complexes are described in Section 6.1. Exemplary features of organ preservation solutions and processes for their production are described in Section 6.2. Exemplary features of kits and systems are described in Section 6.3. Exemplary features of ex-vivo organ and tissue preservation processes, organs and tissues obtained thereby, and transplantation methods are described in Section 6.4.

### 6.1. Lipid Binding Protein-Based Complexes

### 6.1.1. HDL and HDL Mimetic-Based Complexes

In one aspect, the lipid binding protein-based complexes comprise HDL or HDL mimetic-based complexes. For example, complexes can comprise a lipoprotein complex as described in U.S. Pat. No. 8,206,750, PCT publication WO 2012/109162, PCT publication WO 2015/173633 A2 (e.g., CER-001) or US 2004/0229794 A1, the contents of each of which are incorporated herein by reference in their entireties. The terms “lipoproteins” and “apolipoproteins” are used interchangeably herein, and unless required otherwise by context, the term “lipoprotein” encompasses lipoprotein mimetics. The terms “lipid binding protein” and “lipid binding polypeptide” are also used interchangeably herein, and unless required otherwise by context, the terms do not connote an amino acid sequence of particular length.

Lipoprotein complexes can comprise a protein fraction (e.g., an apolipoprotein fraction) and a lipid fraction (e.g., a phospholipid fraction). The protein fraction includes one or more lipid-binding protein molecules, such as apolipoproteins, peptides, or apolipoprotein peptide analogs or mimetics, for example one or more lipid binding protein molecules described in Section 6.1.4.

The lipid fraction typically includes one or more phospholipids which can be neutral, negatively charged, positively charged, or a combination thereof. Exemplary phospholipids and other amphipathic molecules which can be included in the lipid fraction are described in Section 6.1.5.

In certain embodiments, the lipid fraction contains at least one neutral phospholipid (e.g., a sphingomyelin (SM)) and, optionally, one or more negatively charged phospholipids. In lipoprotein complexes that include both neutral and negatively charged phospholipids, the neutral and negatively charged phospholipids can have fatty acid chains with the same or different number of carbons and the same or different degree of saturation. In some instances, the neutral and negatively charged phospholipids will have the same acyl tail, for example a C16:0, or palmitoyl, acyl chain. In specific embodiments, particularly those in which egg SM is used as the neutral lipid, the weight ratio of the apolipoprotein fraction:lipid fraction ranges from about 1:2.7 to about 1:3 (e.g., 1:2.7).

Any phospholipid that bears at least a partial negative charge at physiological pH can be used as the negatively charged phospholipid. Non-limiting examples include negatively charged forms, e.g., salts, of phosphatidylinositol, a phosphatidylserine, a phosphatidylglycerol and a phosphatidic acid. In a specific embodiment, the negatively charged phospholipid is 1,2-dipalmitoyl-sn-glycero-3-[phospho-rac-(1-glycerol)], or DPPG, a phosphatidylglycerol. Preferred salts include potassium and sodium salts.

In some embodiments, a lipoprotein complex used in the compositions and methods of the disclosure is a lipoprotein complex as described in U.S. Pat. No. 8,206,750 or WO 2012/109162 (and its U.S. counterpart, US 2012/0232005), the contents of each of which are incorporated herein in its entirety by reference. In particular embodiments, the protein component of the lipoprotein complex is as described in Section 6.1 and preferably in Section 6.1.1 of WO 2012/109162 (and US 2012/0232005), the lipid component is as described in Section 6.2 of WO 2012/109162 (and US 2012/0232005), which can optionally be complexed together in the amounts described in Section 6.3 of WO 2012/109162 (and US 2012/0232005). The contents of each of these sections are incorporated by reference herein. In certain aspects, a lipoprotein complex of the disclosure is in a population of complexes that is at least 85%, at least 90%, at least 95%, at least 97%, or at least 99% homogeneous, as described in Section 6.4 of WO 2012/109162 (and US 2012/0232005), the contents of which are incorporated by reference herein.

In a specific embodiment, a lipoprotein complex that can be used in the compositions and methods of the disclosure comprises 2-4 ApoA-I equivalents, 2 molecules of charged phospholipid, 50-80 molecules of lecithin and 20-50 molecules of SM.

In another specific embodiment, a lipoprotein complex that can be used in the compositions and methods of the disclosure comprises 2-4 ApoA-I equivalents, 2 molecules of charged phospholipid, 50 molecules of lecithin and 50 molecules of SM.

In yet another specific embodiment, a lipoprotein complex that can be used in the compositions and methods of the disclosure comprises 2-4 ApoA-I equivalents, 2 molecules of charged phospholipid, 80 molecules of lecithin and 20 molecules of SM.

In yet another specific embodiment, a lipoprotein complex that can be used in the compositions and methods of the disclosure comprises 2-4 ApoA-I equivalents, 2 molecules of charged phospholipid, 70 molecules of lecithin and 30 molecules of SM.

In yet another specific embodiment, a lipoprotein complex that can be used in the compositions and methods of the disclosure comprises 2-4 ApoA-I equivalents, 2 molecules of charged phospholipid, 60 molecules of lecithin and 40 molecules of SM.

In a specific embodiment, a lipoprotein complex that can be used in the compositions and methods of the disclosure consists essentially of 2-4 ApoA-I equivalents, 2 molecules of charged phospholipid, 50-80 molecules of lecithin and 20-50 molecules of SM.

In another specific embodiment, a lipoprotein complex that can be used in the compositions and methods of the disclosure consists essentially of 2-4 ApoA-I equivalents, 2 molecules of charged phospholipid, 50 molecules of lecithin and 50 molecules of SM.

In yet another specific embodiment, a lipoprotein complex that can be used in the compositions and methods of the disclosure consists essentially of 2-4 ApoA-I equivalents, 2 molecules of charged phospholipid, 80 molecules of lecithin and 20 molecules of SM.

In yet another specific embodiment, a lipoprotein complex that can be used in the compositions and methods of the disclosure consists essentially of 2-4 ApoA-I equivalents, 2 molecules of charged phospholipid, 70 molecules of lecithin and 30 molecules of SM.

In yet another specific embodiment, a lipoprotein complex that can be used in the compositions and methods of the disclosure consists essentially of 2-4 ApoA-I equivalents, 2 molecules of charged phospholipid, 60 molecules of lecithin and 40 molecules of SM.

In a specific embodiment, a lipoprotein complex that can be used in the compositions and methods of the disclosure comprises a lipid component that comprises about 90 to 99.8 wt % SM and about 0.2 to 10 wt % negatively charged phospholipid, for example, about 0.2-1 wt %, 0.2-2 wt %, 0.2-3 wt %, 0.2-4 wt %, 0.2-5 wt %, 0.2-6 wt %, 0.2-7 wt %, 0.2-8 wt %, 0.2-9 wt %, or 0.2-10 wt % total negatively charged phospholipid(s). In another specific embodiment, a lipoprotein complex that can be used in the methods of the disclosure comprises about 90 to 99.8 wt % lecithin and about 0.2 to 10 wt % negatively charged phospholipid, for example, about 0.2-1 wt %, 0.2-2 wt %, 0.2-3 wt %, 0.2-4 wt %, 0.2-5 wt %, 0.2-6 wt %, 0.2-7 wt %, 0.2-8 wt %, 0.2-9 wt % or 0.2-10 wt % total negatively charged phospholipid(s).

In a specific embodiment, a lipoprotein complex that can be used in the compositions and methods of the disclosure comprises a lipid component that consists essentially of about 90 to 99.8 wt % SM and about 0.2 to 10 wt % negatively charged phospholipid, for example, about 0.2-1 wt %, 0.2-2 wt %, 0.2-3 wt %, 0.2-4 wt %, 0.2-5 wt %, 0.2-6 wt %, 0.2-7 wt %, 0.2-8 wt %, 0.2-9 wt %, or 0.2-10 wt % total negatively charged phospholipid(s). In another specific embodiment, a lipoprotein complex that can be used in the methods of the disclosure consists essentially of about 90 to 99.8 wt % lecithin and about 0.2 to 10 wt % negatively charged phospholipid, for example, about 0.2-1 wt %, 0.2-2 wt %, 0.2-3 wt %, 0.2-4 wt %, 0.2-5 wt %, 0.2-6 wt %, 0.2-7 wt %, 0.2-8 wt %, 0.2-9 wt % or 0.2-10 wt % total negatively charged phospholipid(s).

In still another specific embodiment, a lipoprotein complex that can be used in the compositions and methods of the disclosure comprises a lipid fraction that comprises about 9.8 to 90 wt % SM, about 9.8 to 90 wt % lecithin and about 0.2-10 wt % negatively charged phospholipid, for example, from about 0.2-1 wt %, 0.2-2 wt %, 0.2-3 wt %, 0.2-4 wt %, 0.2-5 wt %, 0.2-6 wt %, 0.2-7 wt %, 0.2-8 wt %, 0.2-9 wt %, to 0.2-10 wt % total negatively charged phospholipid(s).

In still another specific embodiment, a lipoprotein complex that can be used in the compositions and methods of the disclosure comprises a lipid fraction that consists essentially of about 9.8 to 90 wt % SM, about 9.8 to 90 wt % lecithin and about 0.2-10 wt % negatively charged phospholipid, for example, from about 0.2-1 wt %, 0.2-2 wt %, 0.2-3 wt %, 0.2-4 wt %, 0.2-5 wt %, 0.2-6 wt %, 0.2-7 wt %, 0.2-8 wt %, 0.2-9 wt %, to 0.2-10 wt % total negatively charged phospholipid(s).

In another specific embodiment, a lipoprotein complex that can be used in the compositions and methods of the disclosure comprises an ApoA-I apolipoprotein and a lipid fraction, wherein the lipid fraction comprises sphingomyelin and about 3 wt % of a negatively charged phospholipid, wherein the molar ratio of the lipid fraction to the ApoA-I apolipoprotein is about 2:1 to 200:1, and wherein said complex is a small or large discoidal particle containing 2-4 ApoA-I equivalents.

In another specific embodiment, a lipoprotein complex that can be used in the compositions and methods of the disclosure comprises an ApoA-I apolipoprotein and a lipid fraction, wherein the lipid fraction consists essentially of sphingomyelin and about 3 wt % of a negatively charged phospholipid, wherein the molar ratio of the lipid fraction to the ApoA-I apolipoprotein is about 2:1 to 200:1, and wherein said complex is a small or large discoidal particle containing 2-4 ApoA-I equivalents.

HDL-based or HDL mimetic-based complexes can include a single type of lipid-binding protein, or mixtures of two or more different lipid-binding proteins, which may be derived from the same or different species. Although not required, the complexes will preferably comprise lipid-binding proteins that are derived from, or correspond in amino acid sequence to, the animal species being treated or the species of the organ being preserved, in order to avoid inducing an immune response to the therapy. Thus, for treatment of human patients and/or preservation of human organs, lipid-binding proteins of human origin are preferably used. The use of peptide mimetic apolipoproteins may also reduce or avoid an immune response.

In some embodiments, the lipid component includes two types of phospholipids: a sphingomyelin (SM) and a negatively charged phospholipid. Exemplary SMs and negatively charged lipids are described in Section 6.1.5.1.

Lipid components including SM can optionally include small quantities of additional lipids. Virtually any type of lipids may be used, including, but not limited to, lysophospholipids, galactocerebroside, gangliosides, cerebrosides, glycerides, triglycerides, and cholesterol and its derivatives.

When included, such optional lipids will typically comprise less than about 15 wt % of the lipid fraction, although in some instances more optional lipids could be included. In some embodiments, the optional lipids comprise less than about 10 wt %, less than about 5 wt %, or less than about 2 wt %. In some embodiments, the lipid fraction does not include optional lipids.

In a specific embodiment, the phospholipid fraction contains egg SM or palmitoyl SM or phytosphingomyelin and DPPG in a weight ratio (SM:negatively charged phospholipid) ranging from 90:10 to 99:1, more preferably ranging from 95:5 to 98:2. In one embodiment, the weight ratio is 97:3.

The molar ratio of the lipid component to the protein component of complexes of the disclosure can vary, and will depend upon, among other factors, the identity(ies) of the apolipoprotein comprising the protein component, the identities and quantities of the lipids comprising the lipid component, and the desired size of the complex. Because the biological activity of apolipoproteins such as ApoA-I are thought to be mediated by the amphipathic helices comprising the apolipoprotein, it is convenient to express the apolipoprotein fraction of the lipid:apolipoprotein molar ratio using ApoA-I protein equivalents. It is generally accepted that ApoA-I contains 6-10 amphipathic helices, depending upon the method used to calculate the helices. Other apolipoproteins can be expressed in terms of ApoA-I equivalents based upon the number of amphipathic helices they contain. For example, ApoA-IM, which typically exists as a disulfide-bridged dimer, can be expressed as 2 ApoA-I equivalents, because each molecule of ApoA-IM contains twice as many amphipathic helices as a molecule of ApoA-I. Conversely, a peptide apolipoprotein that contains a single amphipathic helix can be expressed as a 1/10-1/6 ApoA-I equivalent, because each molecule contains 1/10-1/6 as many amphipathic helices as a molecule of ApoA-I. In general, the lipid:ApoA-I equivalent molar ratio of the lipoprotein complexes (defined herein as “Ri”) will range from about 105:1 to 110:1. In some embodiments, the Ri is about 108:1. Ratios in weight can be obtained using a MW of approximately 650-800 for phospholipids.

In some embodiments, the molar ratio of lipid:ApoA-I equivalents (“RSM”) ranges from about 80:1 to about 110:1, e.g., about 80:1 to about 100:1. In a specific example, the RSM for complexes can be about 82:1.

In some embodiments, lipoprotein complexes used in the compositions and methods of the disclosure are negatively charged complexes which comprise a protein fraction which is preferably mature, full-length ApoA-I, and a lipid fraction comprising a neutral phospholipid, sphingomyelin (SM), and negatively charged phospholipid.

In a specific embodiment, the lipid component contains SM (e.g., egg SM, palmitoyl SM, phytoSM, or a combination thereof) and negatively charged phospholipid (e.g., DPPG) in a weight ratio (SM:negatively charged phospholipid) ranging from 90:10 to 99:1, more preferably ranging from 95:5 to 98:2, e.g., 97:3.

In specific embodiments, the ratio of the protein component to lipid component can range from about 1:2.7 to about 1:3, with 1:2.7 being preferred. This corresponds to molar ratios of ApoA-I protein to lipid ranging from approximately 1:90 to 1:140. In some embodiments, the molar ratio of protein to lipid in the complex is about 1:90 to about 1:120, about 1:100 to about 1:140, or about 1:95 to about 1:125.

In particular embodiments, the complex comprises CER-001, CSL-111, CSL-112, CER-522 or ETC-216. In a preferred embodiment, the complex is CER-001.

CER-001 as used in the literature and in the Examples below refers to a complex described in Example 4 of WO 2012/109162. WO 2012/109162 refers to CER-001 as a complex having a 1:2.7 lipoprotein weight:total phospholipid weight ratio with a SM:DPPG weight:weight ratio of 97:3. Example 4 of WO 2012/109162 also describes a method of its manufacture.

When used in the context of a CER-001 dosing regimen or composition of the disclosure, CER-001 refers to a lipoprotein complex whose individual constituents can vary from CER-001 as described in Example 4 of WO 2012/109162 by up to 20%. In certain embodiments, the constituents of the lipoprotein complex vary from CER-001 as described in Example 4 of WO 2012/109162 by up to 10%. Preferably, the constituents of the lipoprotein complex are those described in Example 4 of WO 2012/109162 (plus/minus acceptable manufacturing tolerance variations). The SM in CER-001 can be natural or synthetic. In some embodiments, the SM is a natural SM, for example a natural SM described in WO 2012/109162, e.g., chicken egg SM. In some embodiments, the SM is a synthetic SM, for example a synthetic SM described in WO 2012/109162, e.g., synthetic palmitoylsphingomyelin, for example as described in WO 2012/109162. Methods for synthesizing palmitoylsphingomyelin are known in the art, for example as described in WO 2014/140787. The lipoprotein in CER-001, apolipoprotein A-I (ApoA-I), preferably has an amino acid sequence corresponding to amino acids 25 to 267 of SEQ ID NO:1 of WO 2012/109162 (said SEQ ID NO:1 of WO 2012/109162 disclosed herein as SEQ ID NO:2). ApoA-I can be purified by animal sources (and in particular from human sources) or produced recombinantly. In preferred embodiments, the ApoA-I in CER-001 is recombinant ApoA-I. CER-001 used in a dosing regimen of the disclosure is preferably highly homogeneous, for example at least 80%, at least 85%, at least 90%, at least 95%, at least 97%, at least 98%, or at least 99% homogeneous, as reflected by a single peak in gel permeation chromatography. See, e.g., Section 6.4 of WO 2012/109162.

CSL-111 is a reconstituted human ApoA-I purified from plasma complexed with soybean phosphatidylcholine (SBPC) (Tardif et al., 2007, JAMA 297:1675-1682).

CSL-112 is a formulation of ApoA-I purified from plasma and reconstituted to form HDL suitable for intravenous infusion (Diditchenko et al., 2013, DOI 10.1161/ATVBAHA. 113.301981).

ETC-216 (also known as MDCO-216) is a lipid-depleted form of HDL containing recombinant ApoA-I_{Milano}. See Nicholls et al., 2011, Expert Opin Biol Ther. 11(3):387-94. doi: 10.1517/14712598.2011.557061.

In another embodiment, a complex that can be used in the compositions and methods of the disclosure is CER-522. CER-522 is a lipoprotein complex comprising a combination of three phospholipids and a 22 amino acid peptide, CT80522:

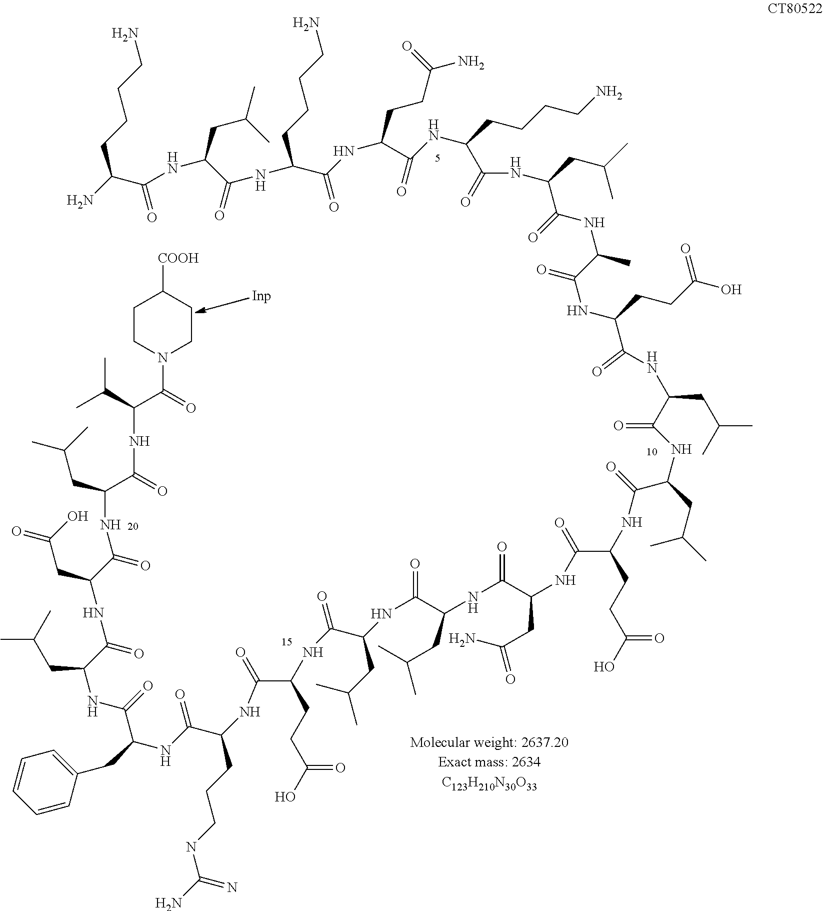 [SMILES: CC(C)C[C@H](NC(=O)[C@H](CCCCN)NC(=O)[C@H](CCC(N)=O)NC(=O)[C@H](CCCCN)NC(=O)[C@H](CC(C)C)NC(=O)[C@@H](N)CCCCN)C(=O)N[C@@H](C)C(=O)N[C@@H](CCC(=O)O)C(=O)N[C@@H](CC(C)C)C(=O)N[C@@H](CC(C)C)C(=O)N[C@@H](CCC(=O)O)C(=O)N[C@@H](CC(N)=O)C(=O)N[C@@H](CC(C)C)C(=O)N[C@@H](CC(C)C)C(=O)N[C@@H](CCC(=O)O)C(=O)N[C@@H](CCCNC(=N)N)C(=O)N[C@@H](Cc1ccccc1)C(=O)N[C@@H](CC(C)C)C(=O)N[C@@H](CC(=O)O)C(=O)N[C@@H](CC(C)C)C(=O)N[C@H](C(=O)N1CCC(C(=O)O)CC1)C(C)C]

The phospholipid component of CER-522 consists of egg sphingomyelin, 1,2-dipalmitoyl-sn-glycero-3-phosphocholine (Dipalmitoylphosphatidylcholine, DPPC) and 1,2-dipalmitoyl-sn-glycero-3-[phospho-rac-(1-glycerol)] (Dipalmitoylphosphatidyl-glycerol, DPPG) in a 48.5:48.5:3 weight ratio. The ratio of peptide to total phospholipids in the CER-522 complex is 1:2.5 (w/w).

In some embodiments, the lipoprotein complex is delipidated HDL. Most HDL in plasma is cholesterol-rich. The lipids in HDL can be depleted, for example partially and/or selectively depleted, e.g., to reduce its cholesterol content. In some embodiments, the delipidated HDL can resemble small a, preβ-1, and other preβ forms of HDL. A process for selective depletion of HDL is described in Sacks et al., 2009, J Lipid Res. 50(5): 894-907.

In certain embodiments, a lipoprotein complex comprises a bioactive agent delivery particle as described in US 2004/0229794.

A bioactive agent delivery particle can comprise a lipid binding polypeptide (e.g., an apolipoprotein as described previously in this Section or in Section 6.1.4), a lipid bilayer (e.g., comprising one or more phospholipids as described previously in this Section or in Section 6.1.5.1), and a bioactive agent (e.g., an anti-cancer agent), wherein the interior of the lipid bilayer comprises a hydrophobic region, and wherein the bioactive agent is associated with the hydrophobic region of the lipid bilayer. In some embodiments, a bioactive agent delivery particle as described in US 2004/0229794.

In some embodiments, a bioactive agent delivery particle does not comprise a hydrophilic core.

In some embodiments, a bioactive agent delivery particle is disc shaped (e.g., having a diameter from about 7 to about 29 nm).

Bioactive agent delivery particles include bilayer-forming lipids, for example phospholipids (e.g., as described previously in this Section or in Section 6.1.5.1). In some embodiments, a bioactive agent delivery particle includes both bilayer-forming and non-bilayer-forming lipids. In some embodiments, the lipid bilayer of a bioactive agent delivery particle includes phospholipids. In one embodiment, the phospholipids incorporated into a delivery particle include dimyristoylphosphatidylcholine (DMPC) and dimyristoylphosphatidylglycerol (DMPG). In one embodiment, the lipid bilayer includes DMPC and DMPG in a 7:3 molar ratio.

In some embodiments, the lipid binding polypeptide is an apolipoprotein (e.g., as described previously in this Section or in Section 6.1.4). The predominant interaction between lipid binding polypeptides, e.g., apolipoprotein molecules, and the lipid bilayer is generally a hydrophobic interaction between residues on a hydrophobic face of an amphipathic structure, e.g., an α-helix of the lipid binding polypeptide and fatty acyl chains of lipids on an exterior surface at the perimeter of the particle. Bioactive agent delivery particles may include exchangeable and/or non-exchangeable apolipoproteins. In one embodiment, the lipid binding polypeptide is ApoA-I.

In some embodiments, bioactive agent delivery particles include lipid binding polypeptide molecules, e.g., apolipoprotein molecules, that have been modified to increase stability of the particle. In one embodiment, the modification includes introduction of cysteine residues to form intramolecular and/or intermolecular disulfide bonds.

In another embodiment, bioactive agent delivery particles include a chimeric lipid binding polypeptide molecule, e.g., a chimeric apolipoprotein molecule, with one or more bound functional moieties, for example one or more targeting moieties and/or one or more moieties having a desired biological activity, e.g., antimicrobial activity, which may augment or work in synergy with the activity of a bioactive agent incorporated into the delivery particle.

### 6.1.2. Apomer Based Complexes

In one aspect, lipid binding protein-based complexes that can be used in the methods and compositions of the disclosure comprise Apomers. Features of Apomers that can be included in Apomer based complexes are described in WO/2019/030575, the contents of which are incorporated herein by reference in their entireties.

Apomers generally comprise an apolipoprotein in monomeric or multimeric form complexed with amphipathic molecules. Generally, Apomers comprise one or more apolipoprotein molecules, each complexed with one or more amphipathic molecules. In certain aspects, the amphipathic molecules together contribute a net charge of at least +1 or −1 per apolipoprotein molecule in an Apomer. Exemplary apolipoproteins that can be used in Apomers are described in Section 6.1.4.1. Exemplary amphipathic molecules are described in Section 6.1.5.

### 6.1.3. Cargomer Based Complexes

In one aspect, lipid binding protein-based complexes that can be used in the methods and compositions of the disclosure comprise Cargomers, which are lipid binding protein-based complexes having one or more cargo moieties. Features of Cargomers that can be included in Cargomer based complexes are described in WO/2019/030574, the contents of which are incorporated herein by reference in their entireties.

Cargomers generally comprise an apolipoprotein in monomeric or multimeric form (e.g., 2, 4, or 8 apolipoprotein molecules) and one or more cargo moieties. Cargo moieties can be amphipathic or non-amphipathic. Amphipathic cargo moieties can solubilize the apolipoprotein and prevent it from aggregating. Where the cargo moieties are not amphipathic or insufficient to solubilize the apolipoprotein molecule(s), the Cargomers can also comprise one or more additional amphipathic molecules to solubilize the apolipoprotein. Thus, reference to amphipathic molecules in the context of the Cargomers encompasses amphipathic molecules that are cargo moieties, amphipathic molecules that are not cargo moieties, or some combination thereof. Preferably, Cargomers are not discoidal, for example as determined using NMR spectroscopy.

Cargo moieties can include biologically active molecules (e.g., drugs, biologics, and/or immunogens) or other agents, for example agents used in diagnostics. As used herein, the terms “molecule” and “agent” also include complexes and conjugates (for example, antibody-drug conjugates). The terms “biologically active,” “diagnostically useful” and the like are not limited to substances with direct pharmacological or biological activity, and may include substances that become active following administration, for example due to metabolism of a prodrug or cleavage of a linker. According, the terms “biologically active” and “diagnostically useful” also includes substances that become biologically active or diagnostically useful after administration, through creation or metabolites or other cleavage products that exert a pharmacological or a biological effect and/or are detectable in a diagnostic test.

Amphipathic molecules in a Cargomer can solubilize the apolipoprotein and/or reduce or minimize apolipoprotein aggregation, and can also have other functions in the Cargomer. For example, amphipathic molecules can have therapeutic utility, and thus may be cargo moieties intended for delivery by the Cargomer upon administration to a subject. Additionally, as discussed in Section 6.1.5 below, amphipathic molecules can be used to anchor a non-amphipathic cargo moiety to the apolipoprotein in the Cargomer. Thus, in some embodiments, a cargo moiety and an amphipathic molecule in a Cargomer are the same. In other embodiments, an anchor moiety and an amphipathic molecule in a Cargomer are the same. In yet other embodiments, cargo moieties, anchor moieties and amphipathic molecules in a Cargomer are the same (for example, where an amphipathic molecule has therapeutic activity and also anchors another biologically active molecule to the apolipoprotein molecule(s)).

Anchor and/or linker moieties are particularly useful for a Cargomer having a cargo moiety that is not an amphipathic molecule.

In some embodiments, at least one of the cargo moieties, a majority of the cargo moieties, or all of the cargo moieties in a Cargomer of the disclosure are coupled to the Cargomer via anchors. In some embodiments, at least one of the cargo moieties in a Cargomer is coupled to the Cargomer via an anchor. In some embodiments, a majority of the cargo moieties in a Cargomer are coupled to the Cargomer via anchors. In some embodiments, all of the cargo moieties in a Cargomer are coupled to the Cargomer via anchors. Each anchor in a Cargomer can be the same or, alternatively, different types of anchors can be included in a single Cargomer (e.g., one type of cargo moiety can be coupled to the Cargomer via one type of anchor and a second type of cargo moiety can be coupled to the Cargomer via a second type of anchor).

In certain aspects, the amphipathic molecules, the cargo, and, if present, the anchors and/or linkers together contribute a net charge of at least +1 or −1 per apolipoprotein molecule in the Cargomer (e.g., +1, +2, +3, −1, −2, or −3). In some embodiments, the net charge is a negative charge. In other embodiments, the net charge is a positive charge. Unless required otherwise by context, charge is measured at physiological pH.

The molar ratio of apolipoprotein molecules to amphipathic molecules in a Cargomer can be but does not necessarily have to be in integers or reflect a one to one relationship between the apolipoprotein and amphipathic molecules. By way of example and not limitation, a Cargomer can have an apolipoprotein to amphipathic molecule molar ratio of 2:5, 8:7, 3:2, or 4:7.

In some embodiments, a Cargomer comprises apolipoprotein molecules complexed with amphipathic molecules in an apolipoprotein:amphipathic molecule molar ratio ranging from 8:1 to 1:15 (e.g., from 8:1 to 1:15, from 7:1 to 1:15, from 6:1 to 1:15, from 5:1 to 1:15, from 4:1 to 1:15, from 3:1 to 1:15, from 2:1 to 1:15, from 1:1 to 1:15, from 8:1 to 1:14, from 7:1 to 1:14, from 6:1 to 1:14, from 5:1 to 1:14, from 4:1 to 1:14, from 3:1 to 1:14, from 2:1 to 1:14, from 1:1 to 1:14, from 8:1 to 1:13, from 7:1 to 1:13, from 6:1 to 1:13, from 5:1 to 1:13, from 4:1 to 1:13, from 3:1 to 1:13, from 2:1 to 1:13, from 1:1 to 1:13, from 8:1 to 1:12, from 7:1 to 1:12, from 6:1 to 1:12, from 5:1 to 1:12, from 4:1 to 1:12, from 3:1 to 1:12, from 2:1 to 1:12, from 1:1 to 1:12, from 8:1 to 1:11, from 7:1 to 1:11, from 6:1 to 1:11, from 5:1 to 1:11, from 4:1 to 1:11, from 3:1 to 1:11, from 2:1 to 1:11, from 1:1 to 1:11, from 8:1 to 1:10, from 7:1 to 1:10, from 6:1 to 1:10, from 5:1 to 1:10, from 4:1 to 1:10, from 3:1 to 1:10, from 2:1 to 1:10, from 1:1 to 1:10, from 8:1 to 1:9, from 7:1 to 1:9, from 6:1 to 1:9, from 5:1 to 1:9, from 4:1 to 1:9, from 3:1 to 1:9, from 2:1 to 1:9, from 1:1 to 1:9, from 8:1 to 1:8, from 7:1 to 1:8, from 6:1 to 1:8, from 5:1 to 1:8, from 4:1 to 1:8, from 3:1 to 1:8, from 2:1 to 1:8, from 1:1 to 1:8, from 8:1 to 1:7, from 7:1 to 1:7, from 6:1 to 1:7, from 5:1 to 1:7, from 4:1 to 1:7, from 3:1 to 1:7, from 2:1 to 1:7, from 1:1 to 1:7, from 8:1 to 1:6, from 7:1 to 1:6, from 6:1 to 1:6, from 5:1 to 1:6, from 4:1 to 1:6, from 3:1 to 1:6, from 2:1 to 1:6, from 1:1 to 1:6, from 8:1 to 1:5, from 7:1 to 1:5, from 6:1 to 1:5, from 5:1 to 1:5, from 4:1 to 1:5, from 3:1 to 1:5, from 2:1 to 1:5, from 1:1 to 1:5, from 8:1 to 1:4, from 7:1 to 1:4, from 6:1 to 1:4, from 5:1 to 1:4, from 4:1 to 1:4, from 3:1 to 1:4, from 2:1 to 1:4, from 1:1 to 1:4, from 8:1 to 1:3, from 7:1 to 1:3, from 6:1 to 1:3, from 5:1 to 1:3, from 4:1 to 1:3, from 3:1 to 1:3, from 2:1 to 1:3, from 1:1 to 1:3, from 8:1 to 1:2, from 7:1 to 1:2, from 6:1 to 1:2, from 5:1 to 1:2, from 4:1 to 1:2, from 3:1 to 1:2, from 2:1 to 1:2, from 1:1 to 1:2, from 8:1 to 1:1, from 7:1 to 1:1, from 6:1 to 1:1, from 5:1 to 1:1, from 4:1 to 1:1, from 3:1 to 1:1, or from 2:1 to 1:1).

In some embodiments, the apolipoprotein to amphipathic molecule molar ratio in the Cargomer ranges from 6:1 to 1:6. In some embodiments, the apolipoprotein to amphipathic molecule molar ratio ranges from 5:1 to 1:6. In some embodiments, the apolipoprotein to amphipathic molecule molar ratio ranges from 4:1 to 1:6. In some embodiments, the apolipoprotein to amphipathic molecule molar ratio ranges from 3:1 to 1:6. In some embodiments, the apolipoprotein to amphipathic molecule molar ratio ranges from 2:1 to 1:6. In some embodiments, the apolipoprotein to amphipathic molecule molar ratio ranges from 5:1 to 1:5. In some embodiments, the apolipoprotein to amphipathic molecule molar ratio ranges from 4:1 to 1:5. In some embodiments, the apolipoprotein to amphipathic molecule molar ratio ranges from 3:1 to 1:5. In some embodiments, the apolipoprotein to amphipathic molecule molar ratio ranges from 2:1 to 1:5. In some embodiments, the apolipoprotein to amphipathic molecule molar ratio ranges from 5:1 to 1:4. In some embodiments, the apolipoprotein to amphipathic molecule molar ratio ranges from 4:1 to 1:4. In some embodiments, the apolipoprotein to amphipathic molecule molar ratio ranges from 3:1 to 1:4. In some embodiments, the apolipoprotein to amphipathic molecule molar ratio ranges from 2:1 to 1:4. In some embodiments, the apolipoprotein to amphipathic molecule molar ratio ranges from 5:1 to 1:3. In some embodiments, the apolipoprotein to amphipathic molecule molar ratio ranges from 4:1 to 1:3. In some embodiments, the apolipoprotein to amphipathic molecule molar ratio ranges from 3:1 to 1:3. In some embodiments, the apolipoprotein to amphipathic molecule molar ratio ranges from 2:1 to 1:3. In some embodiments, the apolipoprotein to amphipathic molecule molar ratio ranges from 5:1 to 1:2. In some embodiments, the apolipoprotein to amphipathic molecule molar ratio ranges from 4:1 to 1:2. In some embodiments, the apolipoprotein to amphipathic molecule molar ratio ranges from 3:1 to 1:2. In some embodiments, the apolipoprotein to amphipathic molecule molar ratio ranges from 2:1 to 1:2. In some embodiments, the apolipoprotein to amphipathic molecule molar ratio ranges from 5:1 to 1:1. In some embodiments, the apolipoprotein to amphipathic molecule molar ratio ranges from 4:1 to 1:1. In some embodiments, the apolipoprotein to amphipathic molecule molar ratio ranges from 3:1 to 1:1. In some embodiments, the apolipoprotein to amphipathic molecule molar ratio ranges from 2:1 to 1:1. In some embodiments, the apolipoprotein to amphipathic molecule molar ratio ranges from 1:1 to 1:6. In some embodiments, the apolipoprotein to amphipathic molecule molar ratio ranges from 1:1 to 1:5. In some embodiments, the apolipoprotein to amphipathic molecule molar ratio ranges from 1:1 to 1:4. In some embodiments, the apolipoprotein to amphipathic molecule molar ratio ranges from 1:1 to 1:3. In some embodiments, the apolipoprotein to amphipathic molecule molar ratio ranges from 1:1 to 1:2. In some embodiments, the apolipoprotein to amphipathic molecule molar ratio ranges from 1:2 to 1:6. In some embodiments, the apolipoprotein to amphipathic molecule molar ratio ranges from 1:2 to 1:5. In some embodiments, the apolipoprotein to amphipathic molecule molar ratio ranges from 1:2 to 1:4. In some embodiments, the apolipoprotein to amphipathic molecule molar ratio ranges from 1:2 to 1:3. In some embodiments, the apolipoprotein to amphipathic molecule molar ratio ranges from 1:3 to 1:6. In some embodiments, the apolipoprotein to amphipathic molecule molar ratio ranges from 1:3 to 1:5. In some embodiments, the apolipoprotein to amphipathic molecule molar ratio ranges from 1:3 to 1:4. In some embodiments, the apolipoprotein to amphipathic molecule molar ratio ranges from 1:4 to 1:6. In some embodiments, the apolipoprotein to amphipathic molecule molar ratio ranges from 1:4 to 1:5. In some embodiments, the apolipoprotein to amphipathic molecule molar ratio ranges from 1:5 to 1:6. In some embodiments, the apolipoprotein to amphipathic molecule molar ratio ranges from 1.5:1 to 1:2. In some embodiments, the apolipoprotein to amphipathic molecule molar ratio ranges from 5:4 to 4:5. In some embodiments, the apolipoprotein to amphipathic molecule molar ratio ranges from 5:3 to 3:5. In some embodiments, the apolipoprotein to amphipathic molecule molar ratio ranges from 5:2 to 2:5. In some embodiments, the apolipoprotein to amphipathic molecule molar ratio ranges from 3:2 to 2:3.

In some embodiments, the ratio of the apolipoprotein molecules to amphipathic molecules is about 1:1. In other embodiments, the ratio of the apolipoprotein molecules to amphipathic molecules is about 1:2. In yet other embodiments, the ratio of the apolipoprotein molecules to amphipathic molecules is about 1:3. In yet other embodiments, the ratio of the apolipoprotein molecules to amphipathic molecules is about 1:4. In yet other embodiments, the ratio of the apolipoprotein molecules to amphipathic molecules is about 1:5. In yet other embodiments, the ratio of the apolipoprotein molecules to amphipathic molecules is about 1:6.

In some embodiments, a Cargomer comprises 1 apolipoprotein molecule.

In other embodiments, a Cargomer comprises 2 apolipoprotein molecules. Cargomers comprising 2 apolipoprotein molecules preferably have a Stokes radius of 3 nm or less. In some embodiments, a Cargomer can comprise 2 apolipoprotein molecules and 1, 2, or 3 negatively charged amphipathic molecules (e.g., negatively charged phospholipid molecules) per apolipoprotein molecule.

In other embodiments, a Cargomer comprises 4 apolipoprotein molecules. Cargomers comprising 4 apolipoprotein molecules preferably have a Stokes radius of 4 nm or less. In some embodiments, a Cargomer can comprise 4 apolipoprotein molecules and 1, 2, or 3 negatively charged amphipathic molecules (e.g., negatively charged phospholipid molecules) per apolipoprotein molecule.

In other embodiments, a Cargomer comprises 8 apolipoprotein molecules. Cargomers comprising 8 apolipoprotein molecules preferably have a Stokes radius of 5 nm or less. In some embodiments, a Cargomer can comprise 8 apolipoprotein molecules and 1, 2, or 3 negatively charged amphipathic molecules (e.g., negatively charged phospholipid molecules) per apolipoprotein molecule. In certain embodiments, the Cargomers of the disclosure do not contain cholesterol and/or a cholesterol derivative (e.g., a cholesterol ester).

In some embodiments, a Cargomer comprises an apolipoprotein to phospholipid ratio in the range of about 1:2 to about 1:3 by weight.

In some embodiments, a Cargomer comprises an apolipoprotein to phospholipid ratio of 1:2.7 by weight.

The Cargomers can be soluble in a biological fluid, for example one or more of lymph, cerebrospinal fluid, vitreous humor, aqueous humor, and blood or a blood fraction (e.g., serum or plasma).

Cargomers may include a targeting functionality, for example to target the Cargomers to a particular cell or tissue type. In some embodiments, the Cargomer includes a targeting moiety attached to an apolipoprotein molecule or an amphipathic molecule. In some embodiments, one or more cargo moieties that are incorporated into the Cargomer has a targeting capability.

### 6.1.4. Lipid Binding Protein Molecules

Lipid binding protein molecules that can be used in the complexes described herein include apolipoproteins such as those described in Section 6.1.4.1 and apolipoprotein mimetic peptides such as those described in Section 6.1.4.2. In some embodiments, the complex comprises a mixture of lipid binding protein molecules. In some embodiments, the complex comprises a mixture of one or more lipid binding protein molecules and one or more apolipoprotein mimetic peptides.

In some embodiments, the complex comprises 1 to 8 ApoA-I equivalents (e.g., 1, 2, 3, 4, 5, 6, 7, 8, 1 to 7, 1 to 6, 1 to 5, 1 to 4, 1 to 3, 1 to 2, 2 to 8, 2 to 6, 2 to 4, 4 to 6, or 4 to 8 ApoA-I equivalents). Lipid binding proteins can be expressed in terms of ApoA-I equivalents based upon the number of amphipathic helices they contain. For example, ApoA-IM, which typically exists as a disulfide-bridged dimer, can be expressed as 2 ApoA-I equivalents, because each molecule of ApoA-IM contains twice as many amphipathic helices as a molecule of ApoA-I. Conversely, a peptide mimetic that contains a single amphipathic helix can be expressed as a 1/10-1/6 ApoA-I equivalent, because each molecule contains 1/10-1/6 as many amphipathic helices as a molecule of ApoA-I.

### 6.1.4.1. Apolipoproteins

Suitable apolipoproteins that can be included in the lipid binding protein-based complexes include apolipoproteins ApoA-I, ApoA-II, ApoA-IV, ApoA-V, ApoB, ApoC-I, ApoC-II, ApoC-III, ApoD, ApoE, ApoJ, ApoH, and any combination of two or more of the foregoing.

Polymorphic forms, isoforms, variants and mutants as well as truncated forms of the foregoing apolipoproteins, the most common of which are Apolipoprotein A-I_{Milano} (ApoA-IM), Apolipoprotein A-I_{Paris} (ApoA-I_{P}), and Apolipoprotein A-Zaragoza (ApoA-I_{Z}), can also be used. Apolipoproteins mutants containing cysteine residues are also known, and can also be used (see, e.g., U.S. Publication No. 2003/0181372). The apolipoproteins may be in the form of monomers or dimers, which may be homodimers or heterodimers. For example, homo- and heterodimers (where feasible) of ApoA-I (Duverger et al., 1996, Arterioscler. Thromb. Vasc. Biol. 16(12):1424-29), ApoA-I_{M} (Franceschini et al., 1985, J. Biol. Chem. 260:1632-35), ApoA-I_{P} (Daum et al., 1999, J. Mol. Med. 77:614-22), ApoA-II (Shelness et al., 1985, J. Biol. Chem. 260(14):8637-46; Shelness et al., 1984, J. Biol. Chem. 259(15):9929-35), ApoA-IV (Duverger et al., 1991, Euro. J. Biochem. 201(2):373-83), ApoE (McLean et al., 1983, J. Biol. Chem. 258(14): 8993-9000), ApoJ and ApoH may be used.

The apolipoproteins can be modified in their primary sequence to render them less susceptible to oxidations, for example, as described in U.S. Publication Nos. 2008/0234192 and 2013/0137628, and U.S. Pat. Nos. 8,143,224 and 8,541,236. The apolipoproteins can include residues corresponding to elements that facilitate their isolation, such as His tags, or other elements designed for other purposes. Preferably, the apolipoprotein in the complex is soluble in a biological fluid (e.g., lymph, cerebrospinal fluid, vitreous humor, aqueous humor, blood, or a blood fraction (e.g., serum or plasma).

In some embodiments, the complex comprises covalently bound lipid-binding protein monomers, e.g., dimeric apolipoprotein A-I_{Milano}, which is a mutated form of ApoA-I containing a cysteine. The cysteine allows the formation of a disulfide bridge which can lead to the formation of homodimers or heterodimers (e.g., ApoA-I Milano-ApoA-II).

In some embodiments, the apolipoprotein molecules comprise ApoA-I, ApoA-II, ApoA-IV, ApoA-V, ApoB, ApoC-I, ApoC-II, ApoC-III, ApoD, ApoE, ApoJ, or ApoH molecules or a combination thereof.

In some embodiments, the apolipoprotein molecules comprise or consist of ApoA-I molecules. In some embodiments, said ApoA-I molecules are human ApoA-I molecules. In some embodiments, said ApoA-I molecules are recombinant. In some embodiments, the ApoA-I molecules are not ApoA-Milano.

In some embodiments, the ApoA-I molecules are Apolipoprotein A-I_{Milano} (ApoA-IM), Apolipoprotein A-I_{Paris} (ApoA-IP), or Apolipoprotein A-I_{Zaragoza} (ApoA-I_{Z}) molecules.

Apolipoproteins can be purified from animal sources (and in particular from human sources) or produced recombinantly as is well-known in the art, see, e.g., Chung et al., 1980, J. Lipid Res. 21(3):284-91; Cheung et al., 1987, J. Lipid Res. 28(8):913-29. See also U.S. Pat. Nos. 5,059,528, 5,128,318, 6,617,134; U.S. Publication Nos. 2002/0156007, 2004/0067873, 2004/0077541, and 2004/0266660; and PCT Publications Nos. WO 2008/104890 and WO 2007/023476. Other methods of purification are also possible, for example as described in PCT Publication No. WO 2012/109162, the disclosure of which is incorporated herein by reference in its entirety.

The apolipoprotein can be in prepro-form, pro-form, or mature form. For example, a complex can comprise ApoA-I (e.g., human ApoA-I) in which the ApoA-I is preproApoA-I, proApoA-I, or mature ApoA-I. In some embodiments, the complex comprises ApoA-I that has at least 90% sequence identity to SEQ ID NO:1:

(SEQ ID NO: 1)
PPQSPWDRVKDLATVYVDVLKDSGRDYVSQFEGSALGKQLNLKLLDNWDS
VTSTFSKLREQLGPVTQEFWDNLEKETEGLRQEMSKDLEEVKAKVQPYLD
DFQKKWQEEMELYRQKVEPLRAELQEGARQKLHELQEKLSPLGEEMRDRA
RAHVDALRTHLAPYSDELRQRLAARLEALKENGGARLAEY

In other embodiments, the complex comprises ApoA-I that has at least 95% sequence identity to SEQ ID NO:1. In other embodiments, the complex comprises ApoA-I that has at least 98% sequence identity to SEQ ID NO:1. In other embodiments, the complex comprises ApoA-I that has at least 99% sequence identity to SEQ ID NO:1. In other embodiments, the complex comprises ApoA-I that has 100% sequence identity to SEQ ID NO:1.

In other embodiments, the complex comprises ApoA-I that has at least 95% sequence identity to amino acids 25 to 267 of SEQ ID NO:2. In other embodiments, the complex comprises ApoA-I that has at least 98% sequence identity to amino acids 25 to 267 of SEQ ID NO:2. In other embodiments, the complex comprises ApoA-I that has at least 99% sequence identity to amino acids 25 to 267 of SEQ ID NO:2. In other embodiments, the complex comprises ApoA-I that has 100% sequence identity to amino acids 25 to 267 of SEQ ID NO:2.

In some embodiments, the complex comprises 1 to 8 apolipoprotein molecules (e.g., 1 to 6, 1 to 4, 1 to 2, 2 to 8, 2 to 6, 2 to 4, 4 to 8, 4 to 6, or 6 to 8 apolipoprotein molecules). In some embodiments, the complex comprises 1 apolipoprotein molecule. In some embodiments, the complex comprises 2 apolipoprotein molecules. In some embodiments, the complex comprises 3 apolipoprotein molecules. In some embodiments, the complex comprises 4 apolipoprotein molecules. In some embodiments, the complex comprises 5 apolipoprotein molecules. In some embodiments, the complex comprises 6 apolipoprotein molecules. In some embodiments, the complex comprises 7 apolipoprotein molecules. In some embodiments, the complex comprises 8 apolipoprotein molecules.

The apolipoprotein molecule(s) can comprise a chimeric apolipoprotein comprising an apolipoprotein and one or more attached functional moieties, such as for example, one or more CRN-001 complex(es), one or more targeting moieties, a moiety having a desired biological activity, an affinity tag to assist with purification, and/or a reporter molecule for characterization or localization studies. An attached moiety with biological activity may have an activity that is capable of augmenting and/or synergizing with the biological activity of a compound or cargo moiety incorporated into a complex of the disclosure. For example, a moiety with biological activity may have antimicrobial (for example, antifungal, antibacterial, anti-protozoal, bacteriostatic, fungistatic, or antiviral) activity. In one embodiment, an attached functional moiety of a chimeric apolipoprotein is not in contact with hydrophobic surfaces of the complex. In another embodiment, an attached functional moiety is in contact with hydrophobic surfaces of the complex. In some embodiments, a functional moiety of a chimeric apolipoprotein may be intrinsic to a natural protein. In some embodiments, a chimeric apolipoprotein includes a ligand or sequence recognized by or capable of interaction with a cell surface receptor or other cell surface moiety.

In one embodiment, a chimeric apolipoprotein includes a targeting moiety that is not intrinsic to the native apolipoprotein, such as for example, S. cerevisiae α-mating factor peptide, folic acid, transferrin, or lactoferrin. In another embodiment, a chimeric apolipoprotein includes a moiety with a desired biological activity that augments and/or synergizes with the activity of a compound or cargo moiety incorporated into a complex of the disclosure. In one embodiment, a chimeric apolipoprotein may include a functional moiety intrinsic to an apolipoprotein. One example of an apolipoprotein intrinsic functional moiety is the intrinsic targeting moiety formed approximately by amino acids 130-150 of human ApoE, which comprises the receptor binding region recognized by members of the low density lipoprotein receptor family. Other examples of apolipoprotein intrinsic functional moieties include the region of ApoB-100 that interacts with the low density lipoprotein receptor and the region of ApoA-I that interacts with scavenger receptor type B 1. In other embodiments, a functional moiety may be added synthetically or recombinantly to produce a chimeric apolipoprotein. Another example is an apolipoprotein with the prepro or pro sequence from another preproapolipoprotein (e.g., prepro sequence from preproapoA-II substituted for the prepro sequence of preproapoA-I). Another example is an apolipoprotein for which some of the amphipathic sequence segments have been substituted by other amphipathic sequence segments from another apolipoprotein.

As used herein, “chimeric” refers to two or more molecules that are capable of existing separately and are joined together to form a single molecule having the desired functionality of all of its constituent molecules. The constituent molecules of a chimeric molecule may be joined synthetically by chemical conjugation or, where the constituent molecules are all polypeptides or analogs thereof, polynucleotides encoding the polypeptides may be fused together recombinantly such that a single continuous polypeptide is expressed. Such a chimeric molecule is termed a fusion protein. A “fusion protein” is a chimeric molecule in which the constituent molecules are all polypeptides and are attached (fused) to each other such that the chimeric molecule forms a continuous single chain. The various constituents can be directly attached to each other or can be coupled through one or more linkers. One or more segments of various constituents can be, for example, inserted in the sequence of an apolipoprotein, or, as another example, can be added N-terminal or C-terminal to the sequence of an apolipoprotein. For example, a fusion protein can comprise an antibody light chain, an antibody fragment, a heavy-chain antibody, or a single-domain antibody.

In some embodiments, a chimeric apolipoprotein is prepared by chemically conjugating the apolipoprotein and the functional moiety to be attached. Means of chemically conjugating molecules are well known to those of skill in the art. Such means will vary according to the structure of the moiety to be attached, but will be readily ascertainable to those of skill in the art. Polypeptides typically contain a variety of functional groups, e.g., carboxylic acid (—COOH), free amino (—NH2), or sulfhydryl (—SH) groups, that are available for reaction with a suitable functional group on the functional moiety or on a linker to bind the moiety thereto. A functional moiety may be attached at the N-terminus, the C-terminus, or to a functional group on an interior residue (i.e., a residue at a position intermediate between the N- and C-termini) of an apolipoprotein molecule. Alternatively, the apolipoprotein and/or the moiety to be tagged can be derivatized to expose or attach additional reactive functional groups.

In some embodiments, fusion proteins that include a polypeptide functional moiety are synthesized using recombinant expression systems. Typically, this involves creating a nucleic acid (e.g., DNA) sequence that encodes the apolipoprotein and the functional moiety such that the two polypeptides will be in frame when expressed, placing the DNA under the control of a promoter, expressing the protein in a host cell, and isolating the expressed protein.

A nucleic acid encoding a chimeric apolipoprotein can be incorporated into a recombinant expression vector in a form suitable for expression in a host cell. As used herein, an “expression vector” is a nucleic acid which, when introduced into an appropriate host cell, can be transcribed and translated into a polypeptide. The vector may also include regulatory sequences such as promoters, enhancers, or other expression control elements (e.g., polyadenylation signals). Such regulatory sequences are known to those skilled in the art (see, e.g., Goeddel, 1990, Gene Expression Technology: Meth. Enzymol. 185, Academic Press, San Diego, Calif.; Berger and Kimmel, Guide to Molecular Cloning Techniques, Methods in Enzymology 152 Academic Press, Inc., San Diego, Calif.; Sambrook et al., 1989, Molecular Cloning—A Laboratory Manual (2nd ed.) Vol. 1-3, Cold Spring Harbor Laboratory, Cold Spring Harbor Press, NY, etc.).

In some embodiments, an apolipoprotein has been modified such that when the apolipoprotein is incorporated into a complex of the disclosure, the modification will increase stability of the complex, confer targeting ability or increase capacity. In one embodiment, the modification includes introduction of cysteine residues into apolipoprotein molecules to permit formation of intramolecular or intermolecular disulfide bonds, e.g., by site-directed mutagenesis. In another embodiment, a chemical crosslinking agent is used to form intermolecular links between apolipoprotein molecules to enhance stability of the complex. Intermolecular crosslinking prevents or reduces dissociation of apolipoprotein molecules from the complex and/or prevents displacement by endogenous apolipoprotein molecules within an individual to whom the complexes are administered. In other embodiments, an apolipoprotein is modified either by chemical derivatization of one or more amino acid residues or by site directed mutagenesis, to confer targeting ability to or recognition by a cell surface receptor.

Complexes can be targeted to a specific cell surface receptor by engineering receptor recognition properties into an apolipoprotein. For example, complexes may be targeted to a particular cell type known to harbor a particular type of infectious agent, for example by modifying the apolipoprotein to render it capable of interacting with a receptor on the surface of the cell type being targeted. For example, complexes may be targeted to macrophages by altering the apolipoprotein to confer recognition by the macrophage endocytic class A scavenger receptor (SR-A). SR-A binding ability can be conferred to a complex by modifying the apolipoprotein by site directed mutagenesis to replace one or more positively charged amino acids with a neutral or negatively charged amino acid. SR-A recognition can also be conferred by preparing a chimeric apolipoprotein that includes an N- or C-terminal extension having a ligand recognized by SR-A or an amino acid sequence with a high concentration of negatively charged residues. Complexes comprising apoplipoproteins can also interact with apolipoprotein receptors such as, but not limited to, ABCA1 receptors, ABCG1 receptors, Megalin, Cubulin and HDL receptors such as SR-B1.

A complex can comprise a lipid binding protein (e.g., an apolipoprotein molecule) which anchors a cargo moiety to a Cargomer. In some embodiments, the apolipoprotein molecule is coupled to a cargo moiety by a direct bond. In other embodiments, the apolipoprotein molecule is coupled to the cargo moiety by a linker, e.g., as described in Section 6.1.7.

### 6.1.4.2. Apolipoprotein Mimetics

Peptides, peptide analogs, and agonists that mimic the activity of an apolipoprotein (collectively referred to herein as “apolipoprotein peptide mimetics”) can also be used in the complexes described herein, either alone, in combination with one or more other lipid binding proteins. Non-limiting examples of peptides and peptide analogs that correspond to apolipoproteins, as well as agonists that mimic the activity of ApoA-I, ApoA-IM, ApoA-II, ApoA-IV, and ApoE, that are suitable for inclusion in the complexes and compositions described herein are disclosed in U.S. Pat. Nos. 6,004,925, 6,037,323 and 6,046,166 (issued to Dasseux et al.), U.S. Pat. No. 5,840,688 (issued to Tso), U.S. Pat. No. 6,743,778 (issued to Kohno), U.S. Publication Nos. 2004/0266671, 2004/0254120, 2003/0171277 and 2003/0045460 (to Fogelman), U.S. Publication No. 2006/0069030 (to Bachovchin), U.S. Publication No. 2003/0087819 (to Bielicki), U.S. Publication No. 2009/0081293 (to Murase et al.), and PCT Publication No. WO/2010/093918 (to Dasseux et al.), the disclosures of which are incorporated herein by reference in their entireties. These peptides and peptide analogues can be composed of L-amino acid or D-amino acids or mixture of L- and D-amino acids. They may also include one or more non-peptide or amide linkages, such as one or more well-known peptide/amide isosteres. Such apolipoprotein peptide mimetic can be synthesized or manufactured using any technique for peptide synthesis known in the art, including, e.g., the techniques described in U.S. Pat. Nos. 6,004,925, 6,037,323 and 6,046,166.

In some embodiments, the lipid binding protein molecules comprise apolipoprotein peptide mimetic molecules and optionally one or more apolipoprotein molecules such as those described above.

In some embodiments, the apolipoprotein peptide mimetic molecules comprise an ApoA-I peptide mimetic, ApoA-II peptide mimetic, ApoA-IV peptide mimetic, or ApoE peptide mimetic or a combination thereof.

A complex of the disclosure can comprise an apolipoprotein peptide mimetic molecule which anchors a cargo moiety to the complex. In some embodiments, the apolipoprotein peptide mimetic molecule is coupled to the cargo moiety by a direct bond. In other embodiments, the apolipoprotein peptide mimetic molecule is coupled to the cargo moiety by a linker, e.g., as described in Section 6.1.7.

### 6.1.5. Amphipathic Molecules

An amphipathic molecule is a molecule that possesses both hydrophobic (apolar) and hydrophilic (polar) elements. Amphipathic molecules that can be used in complexes described herein include lipids (e.g., as described in Section 6.1.5.1), detergents (e.g., as described in Section 6.1.5.2), fatty acids (e.g., as described in Section 6.1.5.3), and apolar molecules and sterols covalently attached to polar molecules such as, but not limited to, sugars or nucleic acids (e.g., as described in Section 6.1.5.4).

The complexes can include a single class of amphipathic molecule (e.g., a single species of phospholipids or a mixture of phospholipids), or can contain a combination of classes of amphipathic molecules (e.g., phospholipids and detergents). The complex can contain one species of amphipathic molecules or a combination of amphipathic molecules configured to facilitate solubilization of the lipid binding protein molecule(s).

In some embodiments, Apomer and/or Cargomer-based complexes comprise only an amount of amphipathic molecules sufficient to solubilize the lipid binding protein molecules. In other words, an Apomer and/or Cargomer-based complex can comprise the minimum amount of one or more amphipathic molecules necessary to solubilize the lipid binding protein molecules.

In some embodiments, the amphipathic molecules included in comprise a phospholipid, a detergent, a fatty acid, an apolar moiety or sterol covalently attached to a sugar, or a combination thereof (e.g., selected from the types of amphipathic molecules discussed above).

In some embodiments, the amphipathic molecules comprise or consist of phospholipid molecules. In some embodiments, the phospholipid molecules comprise negatively charged phospholipids, neutral phospholipids, positively charged phospholipids or a combination thereof. In some embodiments, the phospholipid molecules contribute a net charge of 1-3 per apolipoprotein molecule in the complex. In some embodiments, the net charge is a negative net charge. In some embodiments, the net charge is a positive net charge. In some embodiments, the phospholipid molecules consist of a combination of negatively charged and neutral phospholipids. In some embodiments, the molar ratio of negatively charge phospholipid to neutral phospholipid ranges from 1:1 to 1:3. In some embodiments, the molar ratio of negatively charged phospholipid to neutral phospholipid is about 1:1 or about 1:2.

In some embodiments, a complex comprises at least one amphipathic molecule which is an anchor.

In some embodiments, the amphipathic molecules comprise neutral phospholipids and negatively charged phospholipids in a weight ratio of 95:5 to 99:1.

### 6.1.5.1. Lipids

Lipid binding protein-based complexes can include one or more lipids. In various embodiments, one or more lipids can be saturated and/or unsaturated, natural and/or synthetic, charged or not charged, zwitterionic or not. In some embodiments, the lipid molecules (e.g., phospholipid molecules) can together contribute a net charge of 1-3 (e.g., 1-3, 1-2, 2-3, 1, 2, or 3) per lipid binding protein molecule in the complex. In some embodiments, the net charge is negative. In other embodiments, the net charge is positive.

In some embodiments, the lipid comprises a phospholipid. Phospholipids can have two acyl chains that are the same or different (for example, chains having a different number of carbon atoms, a different degree of saturation between the acyl chains, different branching of the acyl chains, or a combination thereof). The lipid can also be modified to contain a fluorescent probe (e.g., as described at avantilipids.com/product-category/products/fluorescent-lipids/). Preferably, the lipid comprises at least one phospholipid.

Phospholipids can have unsaturated or saturated acyl chains ranging from about 6 to about 24 carbon atoms (e.g., 6-20, 6-16, 6-12, 12-24, 12-20, 12-16, 16-24, 16-20, or 20-24). In some embodiments, a phospholipid used in a complex of the disclosure has one or two acyl chains of 12, 14, 16, 18, 20, 22, or 24 carbons (e.g., two acyl chains of the same length or two acyl chains of different length).

Non-limiting examples of acyl chains present in commonly occurring fatty acids that can be included in phospholipids are provided in Table 1, below:

TABLE 1

| Length:Number of Unsaturations | Common Name |
|---|---|
| 14:0 | myristic acid |
| 16:0 | palmitic acid |
| 18:0 | stearic acid |
| 18:1 cisΔ⁹ | oleic acid |
| 18:2 cisΔ^{9, 12} | linoleic acid |
| 18:3 cisΔ^{9, 12, 15} | linonenic acid |
| 20:4 cisΔ^{5, 8, 11, 14} | arachidonic acid |
| 20:5 cisΔ^{5, 8, 11, 14, 17} | eicosapentaenoic acid |
| | (an omega-3 fatty acid) |

Lipids that can be present in the complexes of the disclosure include, but are not limited to, small alkyl chain phospholipids, egg phosphatidylcholine, soybean phosphatidylcholine, dipalmitoylphosphatidylcholine, dimyristoylphosphatidylcholine, distearoylphosphatidylcholine 1-myristoyl-2-palmitoylphosphatidylcholine, 1-palmitoyl-2-myristoylphosphatidylcholine, 1-palmitoyl-2-stearoylphosphatidylcholine, 1-stearoyl-2-palmitoylphosphatidylcholine, dioleoylphosphatidylcholine dioleophosphatidylethanolamine, dilauroylphosphatidylglycerol phosphatidylcholine, phosphatidylserine, phosphatidylethanolamine, phosphatidylinositol, phosphatidylglycerols, diphosphatidylglycerols such as dimyristoylphosphatidylglycerol, dipalmitoylphosphatidylglycerol, distearoylphosphatidylglycerol, dioleoylphosphatidylglycerol, dimyristoylphosphatidic acid, dipalmitoylphosphatidic acid, dimyristoylphosphatidylethanolamine, dipalmitoylphosphatidylethanolamine, dimyristoylphosphatidylserine, dipalmitoylphosphatidylserine, brain phosphatidylserine, brain sphingomyelin, palmitoylsphingomyelin, dipalmitoylsphingomyelin, egg sphingomyelin, milk sphingomyelin, phytosphingomyelin, distearoylsphingomyelin, dipalmitoylphosphatidylglycerol salt, phosphatidic acid, galactocerebroside, gangliosides, cerebrosides, dilaurylphosphatidylcholine, (1,3)-D-mannosyl-(1,3)diglyceride, aminophenylglycoside, 3-cholesteryl-6′-(glycosylthio)hexyl ether glycolipids, and cholesterol and its derivatives. Synthetic lipids, such as synthetic palmitoylsphingomyelin or N-palmitoyl-4-hydroxysphinganine-1-phosphocholine (a form of phytosphingomyelin) can be used to minimize lipid oxidation.

In some embodiments, a lipid binding protein-based complex includes two types of phospholipids: a neutral lipid, e.g., lecithin and/or sphingomyelin (abbreviated SM), and a charged phospholipid (e.g., a negatively charged phospholipid). A “neutral” phospholipid has a net charge of about zero at physiological pH. In many embodiments, neutral phospholipids are zwitterions, although other types of net neutral phospholipids are known and can be used. In some embodiments, the molar ratio of the charged phospholipid (e.g., negatively charged phospholipid) to neutral phospholipid ranges from 1:1 to 1:3, for example, about 1:1, about 1:2, or about 1:3.

The neutral phospholipid can comprise, for example, one or both of the lecithin and/or SM, and can optionally include other neutral phospholipids. In some embodiments, the neutral phospholipid comprises lecithin, but not SM. In other embodiments, the neutral phospholipid comprises SM, but not lecithin. In still other embodiments, the neutral phospholipid comprises both lecithin and SM. All of these specific exemplary embodiments can include neutral phospholipids in addition to the lecithin and/or SM, but in many embodiments do not include such additional neutral phospholipids.

As used herein, the expression “SM” includes sphingomyelins derived or obtained from natural sources, as well as analogs and derivatives of naturally occurring SMs that are impervious to hydrolysis by LCAT, as is naturally occurring SM. SM is a phospholipid very similar in structure to lecithin, but, unlike lecithin, it does not have a glycerol backbone, and hence does not have ester linkages attaching the acyl chains. Rather, SM has a ceramide backbone, with amide linkages connecting the acyl chains. SM can be obtained, for example, from milk, egg or brain. SM analogues or derivatives can also be used. Non-limiting examples of useful SM analogues and derivatives include, but are not limited to, palmitoylsphingomyelin, N-palmitoyl-4-hydroxysphinganine-1-phosphocholine (a form of phytosphingomyelin), palmitoylsphingomyelin, stearoylsphingomyelin, D-erythro-N-16:0-sphingomyelin and its dihydro isomer, D-erythro-N-16:0-dihydro-sphingomyelin. Synthetic SM such as synthetic palmitoylsphingomyelin or N-palmitoyl-4-hydroxysphinganine-1-phosphocholine (phytosphingomyelin) can be used in order to produce more homogeneous complexes and with fewer contaminants and/or oxidation products than sphingolipids of animal origin. Methods for synthesizing SM are described in U.S. Publication No. 2016/0075634.

Sphingomyelins isolated from natural sources can be artificially enriched in one particular saturated or unsaturated acyl chain. For example, milk sphingomyelin (Avanti Phospholipid, Alabaster, Ala.) is characterized by long saturated acyl chains (i.e., acyl chains having 20 or more carbon atoms). In contrast, egg sphingomyelin is characterized by short saturated acyl chains (i.e., acyl chains having fewer than 20 carbon atoms). For example, whereas only about 20% of milk sphingomyelin comprises C16:0 (16 carbon, saturated) acyl chains, about 80% of egg sphingomyelin comprises C16:0 acyl chains. Using solvent extraction, the composition of milk sphingomyelin can be enriched to have an acyl chain composition comparable to that of egg sphingomyelin, or vice versa.

The SM can be semi-synthetic such that it has particular acyl chains. For example, milk sphingomyelin can be first purified from milk, then one particular acyl chain, e.g., the C16:0 acyl chain, can be cleaved and replaced by another acyl chain. The SM can also be entirely synthesized, by e.g., large-scale synthesis. See, e.g., Dong et al., U.S. Pat. No. 5,220,043, entitled Synthesis of D-erythro-sphingomyelins, issued Jun. 15, 1993; Weis, 1999, Chem. Phys. Lipids 102 (1-2):3-12. SM can be fully synthetic, e.g., as described in U.S. Publication No. 2014/0275590.

The lengths and saturation levels of the acyl chains comprising a semi-synthetic or a synthetic SM can be selectively varied. The acyl chains can be saturated or unsaturated, and can contain from about 6 to about 24 carbon atoms. Each chain can contain the same number of carbon atoms or, alternatively each chain can contain different numbers of carbon atoms. In some embodiments, the semi-synthetic or synthetic SM comprises mixed acyl chains such that one chain is saturated and one chain is unsaturated. In such mixed acyl chain SMs, the chain lengths can be the same or different. In other embodiments, the acyl chains of the semi-synthetic or synthetic SM are either both saturated or both unsaturated. Again, the chains can contain the same or different numbers of carbon atoms. In some embodiments, both acyl chains comprising the semi-synthetic or synthetic SM are identical. In a specific embodiment, the chains correspond to the acyl chains of a naturally-occurring fatty acid, such as for example oleic, palmitic or stearic acid. In another embodiment, SM with saturated or unsaturated functionalized chains is used. In another specific embodiment, both acyl chains are saturated and contain from 6 to 24 carbon atoms. Non-limiting examples of acyl chains present in commonly occurring fatty acids that can be included in semi-synthetic and synthetic SMs are provided in Table 1, above.

In some embodiments, the SM is palmitoyl SM, such as synthetic palmitoyl SM, which has C16:0 acyl chains, or is egg SM, which includes as a principal component palmitoyl SM.

In a specific embodiment, functionalized SM, such as phytosphingomyelin, is used.

Lecithin can be derived or isolated from natural sources, or it can be obtained synthetically. Examples of suitable lecithins isolated from natural sources include, but are not limited to, egg phosphatidylcholine and soybean phosphatidylcholine. Additional non-limiting examples of suitable lecithins include, dipalmitoylphosphatidylcholine, dimyristoylphosphatidylcholine, distearoylphosphatidylcholine 1-myristoyl-2-palmitoylphosphatidylcholine, 1-palmitoyl-2-myristoylphosphatidylcholine, 1-palmitoyl-2-stearoylphosphatidylcholine, 1-stearoyl-2-palmitoylphosphatidylcholine, 1-palmitoyl-2-oleoylphosphatidylcholine, 1-oleoyl-2-palmitylphosphatidylcholine, dioleoylphosphatidylcholine and the ether derivatives or analogs thereof.

Lecithins derived or isolated from natural sources can be enriched to include specified acyl chains. In embodiments employing semi-synthetic or synthetic lecithins, the identity(ies) of the acyl chains can be selectively varied, as discussed above in connection with SM. In some embodiments of the complexes described herein, both acyl chains on the lecithin are identical. In some embodiments of complexes that include both SM and lecithin, the acyl chains of the SM and lecithin are all identical. In a specific embodiment, the acyl chains correspond to the acyl chains of myristic, palmitic, oleic or stearic acid.

The complexes of the disclosure can include one or more negatively charged phospholipids (e.g., alone or in combination with one or more neutral phospholipids). As used herein, “negatively charged phospholipids” are phospholipids that have a net negative charge at physiological pH. The negatively charged phospholipid can comprise a single type of negatively charged phospholipid, or a mixture of two or more different, negatively charged, phospholipids. In some embodiments, the charged phospholipids are negatively charged glycerophospholipids. Specific examples of suitable negatively charged phospholipids include, but are not limited to, a 1,2-dipalmitoyl-sn-glycero-3-[phospho-rac-(1-glycerol)], a phosphatidylglycerol, a phosphatidylinositol, a phosphatidylserine, a phosphatidic acid, and salts thereof (e.g., sodium salts or potassium salts). In some embodiments, the negatively charged phospholipid comprises one or more of phosphatidylinositol, phosphatidylserine, phosphatidylglycerol and/or phosphatidic acid. In a specific embodiment, the negatively charged phospholipid comprises or consists of a salt of a phosphatidylglycerol or a salt of a phosphatidylinositol. In another specific embodiment, the negatively charged phospholipid comprises or consists of 1,2-dipalmitoyl-sn-glycero-3-[phospho-rac-(1-glycerol)], or DPPG, or a salt thereof.

The negatively charged phospholipids can be obtained from natural sources or prepared by chemical synthesis. In embodiments employing synthetic negatively charged phospholipids, the identities of the acyl chains can be selectively varied, as discussed above in connection with SM. In some embodiments of the complexes of the disclosure, both acyl chains on the negatively charged phospholipids are identical. In some embodiments, the acyl chains all types of phospholipids included in a complex of the disclosure are all identical. In a specific embodiment, the complex comprises negatively charged phospholipid(s), and/or SM all having C16:0 or C16:1 acyl chains. In a specific embodiment the fatty acid moiety of the SM is predominantly C16:1 palmitoyl. In one specific embodiment, the acyl chains of the charged phospholipid(s), lecithin and/or SM correspond to the acyl chain of palmitic acid. In yet another specific embodiment, the acyl chains of the charged phospholipid(s), lecithin and/or SM correspond to the acyl chain of oleic acid.

Examples of positively charged phospholipids that can be included in the complexes of the disclosure include N1-[2-((1S)-1-[(3-aminopropyl)amino]-4-[di(3-amino-propyl)amino]butylcarboxamido)ethyl]-3,4-di[oleoyloxy]-benzamide, 1,2-di-O-octadecenyl-3-trimethylammonium propane, 1,2-dimyristoleoyl-sn-glycero-3-ethylphosphocholine, 1-palmitoyl-2-oleoyl-sn-glycero-3-ethylphosphocholine, 1,2-dioleoyl-sn-glycero-3-ethylphosphocholine, 1,2-distearoyl-sn-glycero-3-ethylphosphocholine, 1,2-dipalmitoyl-sn-glycero-3-ethylphosphocholine, 1,2-dimyristoyl-sn-glycero-3-ethylphosphocholine, 1,2-dilauroyl-sn-glycero-3-ethylphosphocholine, 1,2-dilauroyl-sn-glycero-3-ethylphosphocholine, 1,2-dioleoyl-3-dimethylammonium-propane 1,2-dimyristoyl-3-dimethylammonium-propane, 1,2-dipalmitoyl-3-dimethylammonium-propane, N-(4-carboxybenzyl)-N,N-dimethyl-2,3-bis(oleoyloxy)propan-1-aminium, 1,2-dioleoyl-3-trimethylammonium-propane, 1,2-dioleoyl-3-trimethylammonium-propane, 1,2-stearoyl-3-trimethylammonium-propane, 1,2-dipalmitoyl-3-trimethylammonium-propane, 1,2-dimyristoyl-3-trimethylammonium-propane, N-[1-(2,3-dimyristyloxy)propyl]-N, N-dimethyl-N-(2-hydroxyethyl) ammonium bromide, N,N,N-trimethyl-2-bis[(1-oxo-9-octadecenyl)oxy]-(Z,Z)-1propanaminium methyl sulfate, and salts thereof (e.g., chloride or bromide salts).

The lipids used are preferably at least 95% pure, and/or have reduced levels of oxidative agents (such as but not limited to peroxides). Lipids obtained from natural sources preferably have fewer polyunsaturated fatty acid moieties and/or fatty acid moieties that are not susceptible to oxidation. The level of oxidation in a sample can be determined using an iodometric method, which provides a peroxide value, expressed in milli-equivalent number of isolated iodines per kg of sample, abbreviated meq O/kg. See, e.g., Gray, 1978, Measurement of Lipid Oxidation: A Review, Journal of the American Oil Chemists Society 55:539-545; Heaton, F. W. and Ur, Improved Iodometric Methods for the Determination of Lipid Peroxides, 1958, Journal of the Science of Food and Agriculture 9:781-786. Preferably, the level of oxidation, or peroxide level, is low, e.g., less than 5 meq O/kg, less than 4 meq O/kg, less than 3 meq O/kg, or less than 2 meq O/kg.

Complexes can in some embodiments include small quantities of additional lipids. Virtually any type of lipids can be used, including, but not limited to, lysophospholipids, galactocerebroside, gangliosides, cerebrosides, glycerides, triglycerides, and sterols and sterol derivatives (e.g., a plant sterol, an animal sterol, such as cholesterol, or a sterol derivative, such as a cholesterol derivative). For example, a complex of the disclosure can contain cholesterol or a cholesterol derivative, e.g., a cholesterol ester. The cholesterol derivative can also be a substituted cholesterol or a substituted cholesterol ester. The complexes of the disclosure can also contain an oxidized sterol such as, but not limited to, oxidized cholesterol or an oxidized sterol derivative (such as, but not limited to, an oxidized cholesterol ester). In some embodiments, the complexes do not include cholesterol and/or its derivatives (such as a cholesterol ester or an oxidized cholesterol ester).

### 6.1.5.2. Detergents

The complexes can contain one or more detergents. The detergent can be zwitterionic, nonionic, cationic, anionic, or a combination thereof. Exemplary zwitterionic detergents include 3-[(3-Cholamidopropyl)dimethylammonio]-1-propanesulfonate (CHAPS), 3-[(3-Cholamidopropyl)dimethylammonio]-2-hydroxy-1-propanesulfonate (CHAPSO), and N,N-dimethyldodecylamine N-oxide (LDAO). Exemplary nonionic detergents include D-(+)-trehalose 6-monooleate, N-octanoyl-N-methylglucamine, N-nonanoyl-N-methylglucamine, N-decanoyl-N-methylglucamine, 1-(7Z-hexadecenoyl)-rac-glycerol, 1-(8Z-hexadecenoyl)-rac-glycerol, 1-(8Z-heptadecenoyl)-rac-glycerol, 1-(9Z-hexadecenoyl)-rac-glycerol, 1-decanoyl-rac-glycerol. Exemplary cationic detergents include (S)-O-methyl-serine dodecylamide hydrochloride, dodecylammonium chloride, decyltrimethylammonium bromide, and cetyltrimethylammonium sulfate. Exemplary anionic detergents include cholesteryl hemisuccinate, cholate, alkyl sulfates, and alkyl sulfonates.

### 6.1.5.3. Fatty Acids

The complexes can contain one or more fatty acids. The one or more fatty acids can include short-chain fatty acids having aliphatic tails of five or fewer carbons (e.g. butyric acid, isobutyric acid, valeric acid, or isovaleric acid), medium-chain fatty acids having aliphatic tails of 6 to 12 carbons (e.g., caproic acid, caprylic acid, capric acid, or lauric acid), long-chain fatty acids having aliphatic tails of 13 to 21 carbons (e.g., myristic acid, palmitic acid, stearic acid, or arachidic acid), very long chain fatty acids having aliphatic tails of 22 or more carbons (e.g., behenic acid, lignoceric acid, or cerotic acid), or a combination thereof. The one or more fatty acids can be saturated (e.g., caprylic acid, capric acid, lauric acid, myristic acid, palmitic acid, stearic acid, arachidic acid, behenic acid, lignoceric acid, or cerotic acid), unsaturated (e.g., myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, or docosahexaenoic acid) or a combination thereof. Unsaturated fatty acids can be cis or trans fatty acids. In some embodiments, unsaturated fatty acids used in the complexes of the disclosure are cis fatty acids.

### 6.1.5.4. Apolar Molecules and Sterols Attached to a Sugar

The complexes can contain one or more amphipathic molecules that comprise an apolar molecule or moiety (e.g., a hydrocarbon chain, an acyl or diacyl chain) or a sterol (e.g., cholesterol) attached to a sugar (e.g., a monosaccharide such as glucose or galactose, or a disaccharide such as maltose or trehalose). The sugar can be a modified sugar or a substituted sugar. Exemplary amphipathic molecules comprising an apolar molecule attached to a sugar include dodecan-2-yloxy-ß-D-maltoside, tridecan-3-yloxy-ß-D-maltoside, tridecan-2-yloxy-ß-D-maltoside, n-dodecyl-ß-D-maltoside (DDM), n-octyl-ß-D-glucoside, n-nonyl-ß-D-glucoside, n-decyl-ß-D-maltoside, n-dodecyl-β-D-maltopyranoside, 4-n-Dodecyl-α,α-trehalose, 6-n-dodecyl-α,α-trehalose, and 3-n-dodecyl-α,α-trehalose.

In some embodiments, the apolar moiety is an acyl or a diacyl chain.

In some embodiments, the sugar is a modified sugar or a substituted sugar.

### 6.1.6. Anchors

A cargo moiety can be covalently bound to an amphipathic or apolar moiety to facilitate coupling of the cargo moiety to a lipid binding protein-based complex. Amphipathic and apolar moieties can interact with apolar regions in lipid binding protein-based complexes, thereby anchoring cargo moieties attached to amphipathic and apolar moieties to the complexes.

Amphipathic moieties that can be used as anchors include lipids (e.g., as described in Section 6.1.5.1) and fatty acids (e.g., as described in Section 6.1.5.3). In some embodiments, the anchors comprise a sterol or a sterol derivative e.g., a plant sterol, an animal sterol, or a sterol derivative such as a vitamin). For example, sterols such as cholesterol can be covalently bound to a cargo moiety (e.g., via the hydroxyl group at the 3-position of the A-ring of the sterol) and used to anchor a cargo moiety to a complex. Apolar moieties that can be used as anchors include alkyl chains, acyl chains, and diacyl chains. Cargo moieties can be covalently bound to anchor moieties directly or indirectly via a linker (e.g., via a difunctional peptide or other linker described in Section 6.1.7). Cargo moieties that are biologically active may retain their biological activity while covalently bound to the anchor (or linker attached to the anchor), while others may require cleavage of the covalent bond (e.g., by hydrolysis) attaching the cargo moiety to the anchor (or linker attached to the anchor) to regain biological activity.

In some embodiments, at least one cargo moiety is coupled to an anchor. In some embodiments, the anchor comprises an amphipathic and/or apolar moiety. In some embodiments, the anchor comprises an amphipathic moiety. In some embodiments, the amphipathic moiety comprises one of the amphipathic molecules in the complex. In some embodiments, the amphipathic moiety comprises a lipid, a detergent, a fatty acid, an apolar molecule attached to a sugar, or a sterol attached to a sugar.

In some embodiments, the amphipathic moiety comprises a sterol. In some embodiments, the sterol comprise an animal sterol or a plant sterol. In some embodiments, the sterol comprises cholesterol.

In other embodiments, the anchor comprises an apolar moiety. In some embodiments, the apolar moiety comprises an alkyl chain, an acyl chain, or a diacyl chain.

In some embodiments, a cargo moiety is coupled to the anchor by a direct bond.

In some embodiments, a cargo moiety is coupled to the anchor by a linker.

### 6.1.7. Linkers

Linkers comprise a chain of atoms that covalently attach cargo moieties to other moieties in a cargo-carrying complex such as a Cargomer, for example to apolipoprotein molecules, amphipathic molecules, and anchors. A number of linker molecules are commercially available, for example from ThermoFisher Scientific. Suitable linkers are well known to those of skill in the art and include, but are not limited to, straight or branched-chain carbon linkers, heterocyclic carbon linkers, and peptide linkers. A linker can be a bifunctional linker, which is either homobifunctional or heterobifunctional.

Suitable linkers include cleavable and non-cleavable linkers.

A linker may be a cleavable linker, facilitating release of a cargo moiety in vivo. Cleavable linkers include acid-labile linkers (e.g., comprising hydrazine or cis-aconityl), protease-sensitive (e.g., peptidase-sensitive) linkers, photolabile linkers, or disulfide-containing linkers (Chari et al., 1992, Cancer Research 52:127-131; U.S. Pat. No. 5,208,020). A cleavable linker is typically susceptible to cleavage under intracellular conditions. Suitable cleavable linkers include, for example, a peptide linker cleavable by an intracellular protease, such as lysosomal protease or an endosomal protease. In exemplary embodiments, the linker can be a dipeptide linker, such as a valine-citrulline (val-cit) or a phenylalanine-lysine (phe-lys) linker.

A cleavable linker can be pH-sensitive, i.e., sensitive to hydrolysis at certain pH values. Typically, a pH-sensitive linker is hydrolyzable under acidic conditions. For example, an acid-labile linker that is hydrolyzable in the lysosome (e.g., a hydrazone, semicarbazone, thiosemicarbazone, cis-aconitic amide, orthoester, acetal, ketal, or the like) can be used. (See, e.g., U.S. Pat. Nos. 5,122,368; 5,824,805; 5,622,929; Dubowchik and Walker, 1999, Pharm. Therapeutics 83:67-123; Neville et al., 1989, Biol. Chem. 264:14653-14661). Such linkers are relatively stable under neutral pH conditions, such as those in the blood, but are unstable at below pH 5.5 or 5.0, the approximate pH of the lysosome. In certain embodiments, the hydrolyzable linker is a thioether linker (such as, e.g., a thioether attached to the cargo moiety via an acylhydrazone bond (see, e.g., U.S. Pat. No. 5,622,929).

In some embodiments, the linker is cleavable under reducing conditions (e.g., a disulfide linker). A variety of disulfide linkers are known in the art, including, for example, those that can be formed using SATA (N-succinimidyl-5-acetylthioacetate), SPDP (N-succinimidyl-3-(2-pyridyldithio)propionate), SPDB (N-succinimidyl-3-(2-pyridyldithio)butyrate) and SMPT (N-succinimidyloxycarbonyl-alpha-methyl-alpha-(2-pyridyl-dithio)toluene), SPDB and SMPT (see, e.g., Thorpe et al., 1987, Cancer Res. 47:5924-5931; Wawrzynczak et al., In Immunoconjugates: Antibody Conjugates in Radioimagery and Therapy of Cancer (C. W. Vogel ed., Oxford U. Press, 1987. See also, U.S. Pat. No. 4,880,935).

In some embodiments, the linker is cleavable by a cleaving agent, e.g., an enzyme, that is present in the intracellular environment (e.g., within a lysosome or endosome or caveolea). The linker can be, e.g., a peptidyl linker that is cleaved by an intracellular peptidase or protease enzyme, including, but not limited to, a lysosomal or endosomal protease. In some embodiments, the peptidyl linker is at least two amino acids long or at least three amino acids long. Cleaving agents can include cathepsins B and D and plasmin, all of which are known to hydrolyze dipeptide drug derivatives resulting in the release of active drug inside target cells (see, e.g., Dubowchik and Walker, 1999, Pharm. Therapeutics 83:67-123). In some embodiments, the peptidyl linker cleavable by an intracellular protease is a Val-Cit linker or a Phe-Lys linker.

In some embodiments, the linker is a malonate linker (Johnson et al., 1995, Anticancer Res. 15:1387-93), a maleimidobenzoyl linker (Lau et al., 1995, Bioorg-Med-Chem. 3(10):1299-1304), or a 3′-N-amide analog (Lau et al., 1995, Bioorg-Med-Chem. 3(10): 1305-12).

In other embodiments, the linker unit is not cleavable and the cargo moiety is released, for example, by complex degradation. Exemplary non-cleavable linkers include maleimidocaproyl, N-succinimidyl 4-(maleimidomethyl)cyclohexanecarboxylate (SMCC) and N-succinimidyl-4-(iodoacetyl)-aminobenzoate (SIAB).

In some embodiments, a cargo moeity is coupled to an anchor (e.g., as described in Section 6.1.6) by a linker. In some embodiments, the linker coupling the cargo moiety to the anchor is a bifunctional linker. In some embodiments, the linker coupling the cargo moiety to the anchor is a cleavable linker. In some embodiments, the cleavable linker is a dipeptide linker such as a valine-citrulline (val-cit) or a phenylalanine-lysine (phe-lys) linker. In some embodiments, the linker coupling the cargo moiety to the anchor is a non-cleavable linker. Exemplary non-cleavable linkers include maleimidocaproyl, N-succinimidyl 4-(maleimidomethyl)cyclohexanecarboxylate (SMCC) and N-succinimidyl-4-(iodoacetyl)-aminobenzoate (SIAB).

### 6.2. Organ Preservation Solutions

There are a number of commercially available organ preservation solutions. Many of these organ preservation solutions contain components to minimize the damage caused to explanted organs and tissues during storage and transportation. Organ preservation solutions have also been tailored to reduce the likelihood of graft rejection. Organ preservation solutions can include various components, for example, components selected from colloids, impermeants, gases, electrolytes, antioxidants, nutrients and/or metabolic substrates, buffers, and combinations thereof.

Some commercially available kidney preservation solutions include Collins solution, EC solution, University of Wisconsin solution (UW solution), Histidin-Tryptophan-Ketoglutarat Solution (HTK solution), Celsior® solution, Hypertonic Citrate Adenine Solution (HC-A solution and HC-A II solution), phosphate buffered sucrose (PBS) 140, HP16, HBS, B2, Lifor, Ecosol, Biolasol, renal preservation solution 2 (RPS-2), F-M, AQIXRS-I, WMO-II, Institute Georges Lopez-1 (IGL-1®) and CZ-1 solutions (Chen et al., 2019, Cell Transplantation, 28(12): 1472-1489). Various components can be included in organ preservation solutions to minimize ischemic/hypoxic injury and maximize organ function after transplantation.

Exemplary components of commercially available organ preservation solutions are provided in Table 2, below:

TABLE 2

| | EC | UW | HTK | | IGL-1 ® | HC-A |
|---|---|---|---|---|---|---|
| Component | solution | solution | solution | Celsior ® | solution | solution |
| Hydroxyethyl | | 50 | | | | |
| starch (g/L) | | | | | | |
| PEG-35 (g/L) | | | | | 1 | |
| Glucose (mM) | 198 | | | | | |
| Lactobionate (mM) | | 100 | | 80 | 100 | |
| Mannitol (mM) | | | 30 | 60 | | 166 |
| Raffinose (mM) | | 30 | | | 30 | |
| Na⁺ (mM) | 10 | 30 | 15 | 100 | 120 | 80 |
| K⁺ (mM) | 115 | 125 | 9 | 15 | 30 | 80 |
| Mg²⁺ (mM) | | 5 | 4 | 13 | 5 | 41 |
| Ca²⁺ (mM) | | | 0.0015 | 0.26 | 0.5 | |
| Cl⁻ (mM) | 15 | | 50 | 41.5 | 20 | |
| SO₄²⁻ (mM) | | 5 | | | 5 | 41 |
| PO₄3− (mM) | 100 | 25 | | | 25 | |
| HCO³⁻ (mM) | 10 | | | | | |
| Citrate (mM) | | | | | | 55 |
| Allopurinol (mM) | | 1 | | | 1 | |
| Glutathione (mM) | | 3 | | 3 | 3 | |
| Tryptophan (mM) | | | 2 | | | |
| Adenosine (mM) | | 5 | | | 5 | |
| Adenine (mM) | | | | | | 0.38 |
| Glutamic acid (mM) | | | | 20 | | |
| Histidine (mM) | | | 198 | 30 | | |
| Ketoglutarate (mM) | | | 1 | | | |
| Insulin (U/L) | | 40 | | | | |
| Penicillin G (U/L) | | 200,000 | | | | |
| Dexamethasone (mg/L) | | 16 | | | | |

Organ preservation solutions of the disclosure can comprise, for example, a lipid binding protein-based complex and one or more components listed in Table 2. For example, an organ preservation solution can comprise a lipid binding protein-based complex (e.g., CER-001) and one or more components of Celsior® solution, EC solution, UW solution, HTK solution, IGL-1® solution, or HC-A solution. In some embodiments, an organ preservation solution of the disclosure comprises a lipid binding protein-based complex (e.g., CER-001) and the components of Celsior Solution®, EC solution, UW solution, HTK solution, IGL-1® solution, or HC-A solution, optionally where the components of the Celsior® solution, EC solution, UW solution, HTK solution, IGL-1® solution, or HC-A solution are present in the concentrations shown in Table 2 or in concentrations ±20%, ±15%, ±10%, or ±5% of the concentrations shown in Table 2. In some embodiments, an organ preservation solution of the disclosure comprises CER-001 and the components of Celsior® solution. In some embodiments, the CER-001 is present at a concentration of 0.1 mg/ml to 5 mg/ml on a protein basis (e.g., 0.3 mg/ml to 0.5 mg/ml, 0.2 mg/ml to 0.6 mg/ml, 0.1 mg/ml to 1 mg/ml, 1 mg/ml to 2 mg/ml, or 2 mg/ml to 5 mg/ml). In some embodiments, the CER-001 is present at a concentration of 0.4 mg/ml on a protein basis. As used herein, the expression “protein basis” means that an amount of a lipid binding protein-based complex (e.g., CER-001) is calculated based upon the amount of lipid binding protein (e.g., ApoA-I) in the a lipid binding protein-based complex (e.g., CER-001).

Another exemplary organ preservation solution that can be used is PumpProtect® solution, which comprises calcium chloride (dihydrate) at 0.5 mM, HEPES (free acid) at 10 mM, potassium phosphate (monobasic) at 25 mM, mannitol at 30 mM, glucose (anhydrous) at 10 mM, sodium gluconate at 80 mM, magnesium gluconate at 5 mM, D-ribose at 5 mM, pentafraction (HES) at 50 g/L, glutathione (reduced) at 3 mM, adenine (free base) at 3 mM. In some embodiments, an organ preservation solution of the disclosure comprises a lipid binding protein-based complex (e.g., CER-001) and the components of PumpProtect® solution. In some embodiments, the components of the PumpProtect® solution are present in the concentrations listed in this paragraph or +20%, +15%, +10%, or +5%.

Solutions containing chondroitin sulfate and dextran (e.g., Optisol™, Optisol GS™) can be used in solutions for preserving cornea tissue. McCarey-Kaufman (MK) medium, Chen medium, and Cornisol can also be used. For example, a commercially available cornea preservation solution can be supplemented with a lipid binding protein-based complex (e.g., CER-001). In some embodiments, a solution for preserving corneal tissue includes a lipid binding protein-based complex (e.g., CER-001) and one or more (e.g., any one, two, three, four, five, six, seven, or eight) the following: chondroitin sulfate, dextran, sodium bicarbonate, an antibiotic (e.g., gentamycin and/or streptomycin), a mixture of amino acids, sodium pyruvate, L-glutamine, and 2-mercaptoethanol.

Organ preservation solutions of the disclosure can be made, for example, by combining the lipid binding protein-based complex with the other components of the solution. For example, a lipid binding protein-based complex can be combined with a pre-made (e.g., commercially available) organ preservation solution. Alternatively, the components of an organ preservation solution can be combined in any other manner, e.g., sequentially added and mixed.

In some aspects, the disclosure provides organ preservation solution products. Such products can comprise an organ preservation solution of the disclosure in a sealed container, for example, a bag (e.g., containing 1 L of solution) or a bottle (e.g., containing 1 L of solution).

### 6.2.1. Colloids

Colloids, in particular high molecular weight colloids, can be included in organ preservation solutions. In organ preservation solutions, the addition of high molecular weight colloids can sustain the intravascular oncotic pressure and prevent interstitial edema. Exemplary colloids that can be included in organ preservation solution include, but are not limited to, Hydroxyethyl starch (HES) (e.g., 50 kDa), Dextran (e.g., 40 kDa), Poly-ethylene glycol (PEG) such as PEG 35 (35 kDa) or PEG 20 (20 kDa) and combinations thereof.

### 6.2.2. Impermeants

Impermeants can be included in organ preservation solutions to limit cellular edema. The effectiveness of impermeants in preventing cell swelling is generally determined by their molecular weight. Generally, larger molecules are better at preventing cell swelling. Examples of impermeants include, but are not limited to, monosaccharides such as glucose (molecular weight 180 kDa), mannitol (molecular weight 182 kDa), sucrose (molecular weight 342 Da), raffinose (molecular weight 504 kDa), lactobionate and combinations thereof.

### 6.2.3. Gases

Several gases have been used to reduce ischemic/hypoxic injury in organ transplantation, including oxygen (O₂), hydrogen (H₂), carbon monoxide (CO), nitric oxide (NO), hydrogen sulfide (H₂S) and argon (Ar). Gases can be added to organ preservation solutions.

### 6.2.4. Electrolytes

Electrolytes, e.g., from salts, can be included in organ preservation solutions to help maintain electrolyte homeostasis in the donor organ. Exemplary electrolytes include, but are not limited to, Nat, K⁺, Mg²⁺, Ca²⁺, Cl⁻, SO₄²⁻, PO₄³⁻, HCO³⁻, citrate and combinations thereof.

### 6.2.5. Antioxidants

Organ preservation solution can include antioxidants and/or radical scavengers to help limit ischemic/hypoxic injury to an explanted organ. Additives that interrupt the ROS generation pathway and scavenging existing ROS can help prevent or reduce ischemic/hypoxic injury during organ preservation. Exemplary antioxidants and/or radical scavengers include: Ilopurinol (a xanthine oxidase inhibitor), reduced glutathione (a thiol containing amino acid), ROS-scavenging amino acids such as tryptophan or L-arginine and histidine, lecithinized superoxide dismutase (lec-SOD), H₂S, N-acetylcysteine, propofol, TMZ, rh-BMP-7, trolox, edaravone, selenium, nicaraven, prostaglandin E1, tanshinone IIA and combinations thereof.

6.2.6. Nutrients and/or Metabolic Substrates

Amino acids can be included in organ preservation solutions to provide nutrients and/or act as metabolic substrates. In some embodiments the amino acid is selected from one or more of: tryptophan, glutamic acid, histidine, L-arginine, N-acetylcysteine, and D-cysteine. In some embodiments, nutrients included in an organ preservation solution include, but are not limited to, Cyclic Helix B peptide trophic factors such as bovine neutrophil peptide-1 (BNP-1), substance P (SP), nerve growth factor-β (NGF-β), insulin-like growth factor-1 (IGF-1), epidermal-like growth factor (EGF), hepatocyte growth factor (HGF), recombinant human bone morphogenetic protein-7 (rh BMP-7), lecithinized superoxide dismutase (lec-SOD), TNF-receptor fusion protein (TNF-RFP) and combinations thereof

### 6.2.7. Buffers

Buffering agents can be included in organ preservation solutions to control cellular pH. In some embodiments the pH of an organ preservation solution of the disclosure is between about 7.0 to about 7.4. In some embodiments, the buffering agent is selected from borates, borate-polyol complexes, succinate, phosphate buffering agents, citrate buffering agents, acetate buffering agents, carbonate buffering agents, organic buffering agents, amino acid buffering agents such as histidine, and combinations thereof.

### 6.2.8. Other Components

Mitochondrial dysfunction is a critical event during ischemia which can result in impaired ATP synthesis and possible ATP depletion. Maintaining mitochondrial integrity and protecting mitochondria function are important requirements of organ preservation solutions. In some embodiments the organ preservation solutions of the disclosure contain one or more mitochondrial protective reagents. Suitable mitochondrial protective reagents include, but are not limited to, H₂S, MitoQ, quinacrine, TMZ, and AP39.

Multiple inflammatory pathways and factors can be activated during reperfusion of the organ which can result in post-ischemic injury. In some embodiments, specific antibodies or pathway inhibitors can be included in organ preservation solutions to modulate the inflammatory responses and attenuate post-ischemic injury. Suitable compounds include endothelial receptor antagonists, TNF-receptor fusion protein (TNF-RFP), ICAM-1 antisense deoxynucleotides, endothelial receptor antagonists, a p38MAPK inhibitor such as FR167653, exogenous CO or CO-releasing molecules, H₂S, O₂, Ar, melagatran, cyclic helix B peptide, TMZ, lec-SOD, Rho-kinase inhibitor HA1077, a thrombin inhibitor such as melagatran, platelet-activating factor (PAF) receptor antagonist, a proteasome inhibitor and combinations thereof.

Ischemic/hypoxic and subsequent reperfusion injury leads to the activation of cell death programs such as apoptosis, necrosis, and autophagy-associated cell death. In some embodiments, the organ preservation solution contains additives that block the activation of cell death programs such as a glucocorticoid for example dexamethasone, a naked caspase-3 siRNA, matrix metalloproteinase (MMP)-2 siRNA, an AMP-activated protein kinase (AMPK) activator and combinations thereof.

In some embodiments, energy substrates such as adenosine may be added to organ preservation solutions to allow for rapid ATP regeneration during preservation.

Other useful additives to the organ preservation solution include agents that aid Ca²⁺ homeostasis such as a calcium channel blocker like verapamil or other pharmacological reagents, which can prevent calcium overload for example H₂S which may inhibit Na⁺/H⁺ exchanger activity via the PI3K/Akt/PKG-dependent pathway.

In certain embodiments, one or more additional additives are included in the organ preservation solution including but not limited to prostaglandin E1, taurine, ranolazine and combinations thereof.

### 6.3. Kits and Systems

In certain aspects, the disclosure provides kits comprising a lipid binding protein-based complex, e.g., as described in Section 6.1 and one or more components of an organ preservation solution, e.g., as described in Section 6.2. In certain embodiments the lipid binding protein-based complex is provided in a kit in the form of a solution. In certain embodiments the lipid binding protein-based complex is provided in a kit in a lyophilized form.

In certain embodiments, one or more components of the kit are provided in a sealed container. In some embodiments, the sealed container is a bag.

In certain embodiments the one or more components of the organ preservation solution is in the form of a solution in the kit.

In certain embodiments the one or more components of the organ preservation solution complex is in a sealed container. In some embodiments, the sealed container is a bag.

In some embodiments, a kit comprises a lipid binding protein-based complex (e.g., CER-001) in one container, and the remaining components of the organ preservation solution in one or more additional containers. For example, a kit can comprise a lipid binding protein-based complex (e.g., CER-001) in one container and Celsior® solution, EC solution, UW solution, HTK solution, IGL-1® solution, or HC-A solution in a second container. In some embodiments, the kit comprises CER-001 in one container and Celsior® solution in another container. A finished organ preservation solution can be made from such kits by combining the lipid binding protein-based complex with the other components.

In another aspect, the disclosure provides systems comprising (a) an organ preservation solution or organ preservation solution product of the disclosure and (b) a perfusion machine and/or an organ (e.g., a kidney, liver, heart, lung, pancreas, intestine, or trachea, which can be from, for example, a mammal such as human or pig). In some embodiments, the system comprises a perfusion machine. In other embodiments, the system comprises an organ. In yet other embodiments, the system comprise a perfusion machine and an organ. Exemplary perfusion machines include, but are not limited to, heart-lung machines, normothermic perfusion machines and subnormothermic perfusion machines.

In another aspect, the disclosure provides systems comprising (a) an organ preservation solution or organ preservation solution product of the disclosure and (b) a tissue (e.g., eye (e.g., cornea or sclera), skin, fat, muscle, bone, cartilage, fetal thymus, or nerve tissue), which can be from, for example, a mammal such as human or pig). In some embodiments, the system further comprises a perfusion machine.

### 6.4. Organs, Tissues, Processes for Organ and Tissue Preservation and Transplantation Methods

In some aspects, the disclosure provides processes for ex vivo organ preservation using the organ preservation solutions of the disclosure. The organ can be, for example, a mammalian organ such as a human or pig organ. Exemplary organs include, but are not limited to kidney, liver, heart, lung, pancreas, intestine, and trachea. In some embodiments, the organ is a kidney. In some embodiments, the organ is an eye.

The processes can comprise, for example, performing machine perfusion of an organ using the organ preservation solution of the disclosure. The organ preservation solution in some embodiments can be diluted with blood, e.g., whole blood. For example, the organ preservation solution can be diluted with whole blood at a volume:volume ratio of organ preservation solution to whole blood from 1:1 to 1:3. In some embodiments, the ratio is 1:1. In other embodiments, the ratio is 1:3. Alternatively, the organ preservation solution can be used without dilution.

The machine perfusion can be, for example, normothermic, e.g., from 30° C. to 38° C., or subnormothermic, e.g., from 2° C. to 8° C. In some embodiments, the machine perfusion is performed from 30° C. to 38° C. In other embodiments, the machine perfusion is performed from 2° C. to 8° C. In other embodiments, the machine perfusion is performed at a temperature between 8° C. and 30° C. (e.g., 20° C. to 25° C.). Machine perfusion can in some embodiments be preceded by flushing of the organ with the organ preservation solution, e.g., with cold organ preservation solution (e.g., 2° C. to 8° C.).

Processes for preserving organs using cold storage (CS) are also provided. In some embodiments, the cold storage comprises storing the organ in the organ preservation solution in the absence of machine perfusion, for example at 2° C. to 6° C. The cold storage can in some embodiments be preceded by a step of flushing the organ with the organ preservation solution, e.g., with cold organ preservation solution (e.g., 2° C. to 8° C.).

Machine perfusion and cold storage can be performed for any suitable length of time, for example from the time an organ is harvested from a donor (or shortly thereafter) to transplantation into a recipient (or shortly before). In some embodiments, machine perfusion or cold storage is performed on an organ for at least 1 hour, at least 2 hours, at least 4 hours, at least 6 hours, and/or up to 1 week, up to 5 days, up to 4 days, up to 3 days, up to 2 days, up to 36 hours, up to 1 day, up to 12 hours, or any range bounded by any two of the foregoing values, e.g., 2 to 4 hours, 2 to 6 hours, 4 to 6 hours, 6 hours to 12 hours, 12 hours to 1 day, 1 day to 2 days, etc.

In some embodiments, a kidney is subject to machine perfusion or cold storage for up to 24 hours or up to 36 hours.

In some embodiments, a liver is subject to machine perfusion or cold storage for up to 12 hours.

In some embodiments, a lung is subject to machine perfusion or cold storage for up to 6 hours or up to 8 hours.

In some embodiments, a heart is subject to machine perfusion or cold storage for up to 4 hours or up to 6 hours.

In some embodiments, a pancreas is subject to machine perfusion or cold storage for up to 12 hours or up to 1 day.

In some embodiments, an intestine is subject to machine perfusion or cold storage for up to 12 hours or up to 1 day.

In some embodiments, trachea is subject to machine perfusion or cold storage for up to 12 hours or up to 1 day.

Processes for organ preservation can further comprise a step of removing the organ from the organ donor. In some embodiments, the organ donor is a living donor (e.g., a kidney donor). In other embodiments, the donor is deceased.

The disclosure further provides methods of organ transplantation, comprising transplanting an organ preserved by the organ preservation processes of the disclosure into a subject in need of an organ transplant. Subjects who can be treated according to the methods described herein are preferably mammals, most preferably human.

In some aspects, the disclosure provides processes for ex vivo tissue preservation using the organ preservation solutions of the disclosure. The tissue can be, for example, a mammalian tissue such as a human or pig tissue. Exemplary tissues include, but are not limited to eye (e.g., cornea or sclera), skin, fat, muscle, bone, cartilage, fetal thymus, and nerve tissue. In some embodiments, the tissue is cornea tissue.

The processes can comprise, for example, storing the tissue (e.g., cold storage (CS)) in an organ preservation solution of the disclosure. In some embodiments, cold storage comprises storing the tissue in the organ preservation solution, for example at 2° C. to 6° C.

Storage of a tissue in an organ preservation solution can be performed for any suitable length of time, for example from the time a tissue is harvested from a donor (or shortly thereafter) to transplantation to a recipient (or shortly before). In some embodiments, storage is performed for at least 1 hour, at least 2 hours, at least 4 hours, at least 6 hours, and/or up to 4 weeks, up to 2 weeks, up to 1 week, up to 5 days, up to 4 days, up to 3 days, up to 2 days, up to 36 hours, up to 1 day, up to 12 hours, or any range bounded by any two of the foregoing values, e.g., 2 to 4 hours, 2 to 6 hours, 4 to 6 hours, 6 hours to 12 hours, 12 hours to 1 day, 1 day to 2 days, 1 day to 1 week, 1 week to 2 weeks, 2 weeks to 4 weeks, etc. In some embodiments, corneal tissue is stored in an organ preservation solution for up to 4 weeks.

Processes for organ preservation can further comprise a step of removing the tissue from the tissue donor. In some embodiments, the tissue donor is a living donor. In other embodiments, the donor is deceased.

The disclosure further provides methods of tissue transplantation, comprising transplanting a tissue preserved by the organ preservation processes of the disclosure to a subject in need of an organ transplant. Subjects who can be treated according to the methods described herein are preferably mammals, most preferably human.

### 7. EXAMPLES

Despite the improvements in recent years in immunosuppressive therapies and in the field of transplant surgical techniques, ischemic/reperfusion injury continues to represent one of the predominant causes of functional loss of transplanted organs.

The interest in new strategies capable of limiting IRI damage has undergone enormous force in recent decades due to a growing technological advancement of the perfusion machines necessary for organ preservation. In addition, being an excellent opportunity to preserve the quality of the organs during transport or preparation of the recipient, perfusion machines allow an organ to be treated pharmacologically before transplantation. In the context of renal IRI damage, several pharmacological approaches have been tried in mouse models such as the monoclonal antibody αCD47Ab capable of modulating oxidative stress, the soluble complement receptor factor sCR1 and the recombinant protein thrombomodulin (rTM) with an anti-coagulant role. However, many of these drugs were not effective when translated into clinical settings (Hameed et al., 2020, Sci Rep. 10(1):6930). Without being bound by theory, it is believed that HDL and HDL mimetics such as CER-001 able to limit IRI damage ex vivo in organ preservation solutions by acting on the same mechanisms of oxidative stress, inflammation and coagulation. Furthermore, HDL and HDL mimetics such as CER-001 comprise an endogenous protein that is not expected to cause the same secondary effects of a monoclonal antibody.

Example 1 describes organ preservation studies in a porcine model of IRI kidney damage. The IRI porcine model is a good animal model of what happens in the human system of kidney transplantation, as it mimics a reduction in serum creatinine, interstitial fibrosis, tubular atrophy, infiltration of circulating leukocytes (Delpech et al 2016, J Transl Med 14, 277).

Another advantage of the porcine model is the ability to control the entire procedure characterized by clamping of the renal artery, from warm and cold ischemia to reperfusion that allows for the processes modulated by drug to be clearly highlighted. The metabolic changes of reduction of intracellular ATP, increase of lactic acid, intracellular accumulation of Ca⁺⁺ and formation of free radicals of O₂ at the mitochondrial level that can be investigated with precision in the model.

Pig and human kidneys are anatomically similar (characterized by a multilocular structure in contrast to the kidneys of rodents and unilobed mice). The body size of the pigs allows surgical procedures similar to those of humans, repeated collections of peripheral blood or renal biopsies for the evaluation and optimization of preclinical perfusion technologies. Finally, the close similarity with the physiology of the immune system allows for the evaluation of the effectiveness of HDL and HDL mimetics such as CER-001 in organ preservation solutions.

### 7.1. Example 1: Evaluation of the Efficacy of CER-001 to Reduce Ischemia/Reperfusion Injury in a Porcine Ex Vivo Perfusion Model

A total of 28 pigs are used for this study. Pigs, with a body weight of 45-60 kg are fasted for 24 hours before the study. All animals are premedicated with an intramuscular mixture of azaperone (8 mg kg-1) and atropine (0.03 mg kg-1) to reduce pharyngeal and tracheal secretion and prevent post-intubation bradycardia. After cannulation of the femoral vein, 600 mL of venous blood for the ex vivo perfusion of the kidneys is withdrawn into sterile blood bags filled with 5,000 IU of heparin each (until the activated clotting time of 480 see, ACT). After anesthesia, both kidneys are approached through a midline abdominal incision. Then, the renal arteries and vein are isolated and a vessel loop is positioned around the renal artery with a right angle clamp. The warm ischemia is induced for 60 minutes by pulling on the vessel loop followed by reperfusion for 3 hours. The animals are then euthanized by an IV administration of 1 mL/kg BW pentobarbital. After organ explant, the kidneys are weighed, and flushed with Celsior solution at 4° C. For each pig, one kidney is statically stored at 4° C. (Cold static storage, CS), while the other kidney is inserted in a machine perfusion system. For the kidney that is perfused, the renal artery is cannulated (retrograde cardioplegia catheter) as well as the renal vein (¼″ tube connector, ¼″ tubing) and ureter (14 Fr. Catheter). The heart rate, oxygen hemoglobin saturation, respiratory gas composition, respiratory rate, tidal volume, airway pressure, systolic blood pressure and central venous pressure are continuously monitored and automatically recorded (Ohmeda Modulus CD; Datex Ohmeda, Helsinki, Finland).

### 7.1.1. Study Design

After organ explant, kidneys are randomized into the following groups:

Group 1: Kidneys cold stored with Celsior® as preservation solution for 6 h at 4° C., (CS) N=7.

Group 2: Kidneys cold stored with Celsior® as preservation solution supplemented with CER-001 (CS+ CER-001), (0.4 mg/ml) for 6 h at 4° C., N=7.

Group 3: Kidneys perfused with normothermic perfusion machine with Celsior® solution+whole blood (1:1 ratio) (NMP) for 6 h at 32° C., N=7.

Group 4: Kidneys perfused with normothermic perfusion machine with Celsior® solution+whole blood (1:1 ratio) (NMP+CER-001) supplemented with CER-001 (0.4 mg/ml) for 6 h at 32° C.

After flushing of all the kidneys through the renal artery with Celsior® solution, each kidney is cannulated. The NMP is performed by an S3 Heart-Lung Machine (HLM) (Stockert GmbH, Germany) equipped with a 3T Heater-Cooler device (Stockert GmbH, Germany) that allows an accurate temperature control. Furthermore, the S3 HLM is equipped with a Sechrist Model 3500CP-G Low Flow gas blender (Sechrist, USA) that ensures a precise gas delivery in terms of sweep flow and fraction of inspired oxygen (FiO2). The perfusion circuit comprises several disposables: Pediatric oxygenator Lilliput2 (LivaNova, Italy) with phosphorylcholine (PC) coating; Centrifugal pump (LivaNova, Italy), Cardiotomy (LivaNova, Italy), PVC ¼ in tubing (LivaNova, Italy). A target mean arterial pressure (MAP) of 75 mmHg is maintained manually by adjusting a custom-designed pump controller and continuously monitored. Renal blood flow (RBF) is monitored via an ultrasonic flow sensor.

### 7.1.2. Perfusate and Urine Sampling and Analysis

Samples of arterial and venous perfusate and urine are collected at distinct time points. Arterial and venous pO2 and PH levels are measured using a blood gas analyzer. Renal metabolic activity is approximated by calculation of oxygen consumption ((caO2−cvO2)*RBF/kidney weight) by using arterial and venous oxygen contents, arterial and venous SO2 and pO2 values and hemoglobin concentrations (ca/vO2=Sa/vO2*1.34*c(Hb)+pa/vO2*0.0031). Urine is collected separately, and the urine output is recorded.

Perfusate plasma samples and urine samples are stored at −80° C. for subsequent analysis. Perfusate samples are analysed for sodium and creatinine levels. Protein, sodium and creatinine concentration is determined in urine samples. Using arterial perfusate and urine levels, creatinine clearance (urine creatinine*urinary flow/plasma creatinine/kidney weight) and fractional excretion of sodium (urinary sodium*plasma creatinine/plasma sodium/urinary creatinine) is calculated.

### Perfusion Parameters

Perfusate solution: Celsior® solution+whole blood (1:1/1:3 ratio based on hematocrit HCT);

Hb: 9-11 mg/dL (if below this parameter, leukocyte-depleted, plasma-free blood obtained via a cell-saver device during the retrieval procedure is added);
U.I. of unfractioned heparin (UFH);
Duration of perfusion: 6 hours;
Perfusion pressure: >75 mmHg;
Renal vein pressure: 0-3 mmHg;
Flow: Adjusted based on metabolic parameters and vascular resistances;
Perfusion temperature: 32° C.

### Monitoring

Flow (mL/min): Continuous monitoring;
Pressures (mmHg): Continuous monitoring;
Intrarenal resistances (mmHg/mL/min): 10 minutes checks;
Blood-gas analyses (acid-base homeostasis, electrolytes, Hb, PaO2, PaCO2 etc.): 30 minutes checks;
Metabolic parameters (DO2, VO2, O2ER): 30 minutes checks;
Perfusion temperature: Continuous monitoring.

### Analyses

### Pre-Perfusion and Post-Perfusion:

Weight

### Blood Gas Measurements:

Arterial: pH, pOs, pCO2, HCO3−, Base excess, Lactate, Na+, K+, Cl−, Ca²⁺
Venous: pH, pOs, pCO2, HCO3−, Base excess, Lactate, Na+, K+, Cl−, Ca²⁺

### Renal Function:

Urine output (ml/h)
Serum creatinine levels (umol/l)
Creatinine clearance (ml/min/100 g)
Renal oxygen consumption (ml/min/gram (pO2 arterieel−pO2 veneus)×(flow rate)/gewicht), Fractional sodium excretion (FENa=[Na⁺]urine×creat.concentration plasma/[Na⁺] plasma×creat.concentration urine)

### Damage Markers:

AST
LDH
Cytokines: IL-6, MCP-1, CRP, IL-8, TNF-α, CXCL-10, PAI-1

Renal Biopsies are performed at T₀ and T_{end} of the procedure, and the following are measured:
ATP
Complement
Histology
Staining H&E morphology, PMN infiltrate, ICAM-1, P-selectin, MPO

### 7.1.3. Results

In preliminary results, improvements in renal hydrodynamics, inflammatory cytokine levels, and histology were observed in explanted kidneys preserved with Celsior® solution supplemented with CER-001 relative to explanted kidneys preserved with Celsior® solution not supplemented with CER-001.

### 7.2. Example 2: In Vitro Evaluation of the Efficacy of CER-001 to Protect Human Endothelial and Tubular Epithelial Cells

The aim of this in vitro study is to evaluate the molecular mechanisms of CER-001 protection on endothelial and tubular epithelial cells. The effect of CER-001 (50 μg/ml and 500 μg/ml) is evaluated in vitro on human endothelial and tubular epithelial cells after C5a and H₂O₂ stimulation followed by exposure to CER-001. The C5a complement component is the most powerful complement anaphylatoxin able to induce a strong inflammation in cell culture and is used to mimic ischemia/reperfusion-related immune activation (Peng et al., 2012, J Am Soc Nephrol. 23(9):1474-1485; Curci et al., 2014, Nephrol Dial Transplant. 29(4):799-808; Franzin et al., 2020, Front Immunol. 11:734). Pre-treatment with CER-001 followed by C5a and H2O2 stimulation is also assessed.

The following analyses are performed:
Vitality test (MTT, Annexin V/PI)
ELISA test for cytokines (as IL-6, MCP-1)
Test for oxidative stress analysis (i.e. AOPP ASSAY KIT Oxiselect)
VCAM, ICAM-1
Western blot for phosphorylation of Ser 1177 in eNOS proteins to detect signalling pathway analysis and HDL-mediated signalling by SR-BI in endothelial cells (Uittenbogaard et al., 2000, J Biol Chem, 275:11278-11283; Adelheid Kratzer et al., 2014, Cardiovascular Research, Vol. 103(3): 350-361).

CER-001 reduces immune activation after C5a and H₂O₂ stimulation.

### 7.3. Example 3: Use of CER-001 in Ex-Vivo Normothermic Machine Perfusion to Improve Discarded Kidney Quality from ECD and DCD Donors

The aim of this Example is to compare the level of kidney function, endothelial dysfunction, cytokine release and histological damage in the setting of new subnormothermic preservation strategies based on the supplementation of Celsior® solution with CER-001. Kidney function, inflammation, apoptosis, endothelial dysfunction and transplant vasculopathy during ex-vivo perfusion of discarded DCD and ECD kidney are assessed. One goal of this study is to optimize commercially available perfusion systems for organ transplantation by delivery of CER-001 to improve graft survival.

### 7.3.1. Study Design

The study has two groups. In both groups, kidneys are from uncontrolled donation after circulatory death (uDCD) donors and/or expanded criteria donors (ECDs), or are declared not transplantable organs based on histological score (Karpinsky score) and indicators able to predict graft outcome such as Kidney Donor Risk Index (KDRI) and Kidney Donor Profile Index (KDPI).

The KDRI was developed for graft assessment and decision-making using donor factors, including age, prevalence of hypertension and diabetes, cause of death, and serum creatinine (sCr) level. Following KDRI, the KDPI has been widely used for the prediction of postoperative graft function and the allocation process.

The scores of KDRI and KDPI are based on several clinical factors. However, age is the most important factor in calculating these scores.

The two groups are:
Control group, which undergoes standard kidney procurement with in-situ cold flush, followed by 6 h hours normothermic machine perfusion with conventional Celsior® solution.
CER-001 group, which undergoes standard kidney procurement with in-situ cold flush, followed by 6 h hours normothermic machine perfusion with conventional Celsior® solution supplemented with CER-001 at 0.4 mg/ml.

### 7.3.2. Analysis

The primary output that is analyzed is kidney function, including urine production:

### Renal Function:

Urine output (ml/h)
Serum creatinine levels (umol/l)
Creatinine clearance (ml/min/100 g)
Renal oxygen consumption (ml/min/gram (pO2 arterieel−pO2 veneus)×(flow rate)/gewicht), Fractional sodium excretion (FENa=[Na+]urine×creat.concentration plasma/[Na+] plasma×creat.concentration urine)

### Pre-Perfusion and Post-Perfusion:

Weight

### Blood Gas Measurements:

Arterial: pH, pOs, pCO2, HCO3−, Base excess, Lactate, Na+, K+, CL−, Ca2+
Venous: pH, pOs, pCO2, HCO3−, Base excess, Lactate, Na+, K+, CL−, Ca2+
   Renal Biopsies are performed at T₀ and T_{end}, and the following are measured:
ATP
Complement
Histology
Staining H&E morphology, PMN infiltrate
ICAM-1, P-selectin, MPO

### Perfusion Parameters:

Perfusate solution: Celsior® solution+whole blood (1:1/1:3 ratio based on hematocrit
HCT) Hb: >7 mg/dL (if below, leukocyte-depleted, plasma-free blood obtained via a cell-saver device during the retrieval procedure is added)
U.I. of unfractioned heparin (UFH)
Perfusion pressure: >75 mmHg
Renal vein pressure: 0-3 mmHg
Flow: Adjusted based on metabolic parameters and vascular resistances
Perfusion temperature: 32° C.

### Monitoring

Flow (mL/min): Continuous monitoring
Pressures (mmHg): Continuous monitoring
Intrarenal resistances (mmHg/mL/min): 10 minutes checks
Blood-gas analyses (acid-base homeostasis, electrolytes, Hb, PaO2, PaCO2 etc.): 30 minute checks
Metabolic parameters (DO2, VO2, O2ER): 30 minutes checks
Perfusion temperature: Continuous monitoring

### Damage Markers:

AST
LDH
Cytokines: IL-6, MCP-1, CRP, IL-8, TNF-alpha, CXCL-10, PAI-1

### 7.3.3. Results

Kidneys subjected to NMP in the presence of CER-001 show reduced renal damage compared to kidneys subjected to NMP in the absence of CER-001. It is believed, without being bound by theory, that CER-001, as well as other lipid binding protein-based complexes, can help preserve organ function and limit organ damage, for example in kidney, liver, heart, lung, pancreas, intestine, and trachea, when used in organ preservation solutions described herein.

### 7.4. Example 4: Evaluation of the Efficacy of CER-001 to Reduce Ischemia/Reperfusion Injury in a Porcine Ex Vivo Perfusion Model

### 7.4.1. Materials and Methods

A total of 10 pigs were stunned with a bitemporal electric shock and subsequently exsanguinated according to normal slaughterhouse procedures (UNI En ISO 9001). After 60 min of warm ischemia, kidneys were flushed and cooled with 500 ml of Ringer Lactate at 4° C., which marked the start of cold ischemia (T−1). Kidneys were then cold stored overnight to increase the level of damage. The following day, blood vessels from the organs were exposed and were connected to a Kidney Perfusion Machine device (TO). Oxygenated pulsatile hypothermic machine perfusion (HMP) was performed at a mean arterial pressure of 25 mmHg for four hours (T4 or Tend) using PumpProtect® solution supplemented with CER-001 PumpProtect® solution not supplemented with CER-001.

Histological analysis was performed at T0, T2, and T_{end} by Periodic acid-Schiff (PAS) staining. Digital slides were acquired and analyzed by the using the AperioScanScope CS2 device (Aperio, Vista, CA, USA). Tubular injury score measurement was performed by Aperio Scan scope software. Tubular damage was scored semi-quantitatively by two blinded observers. The score index in each animal was expressed as a mean value of all scores obtained and expressed as median ±IQR.

CCL2 (MCP-1) and TNF-α levels and aspartate aminotransferase levels were measured in perfusate at T-1, T0, T2, and T_{end}.

CCL2 (MCP-1), IL-6 and endothelin-1 (ET-1) gene expression levels were measured by qRT-PCR in renal biopsies at T₀ and T_{end}.

### 7.4.2. Results

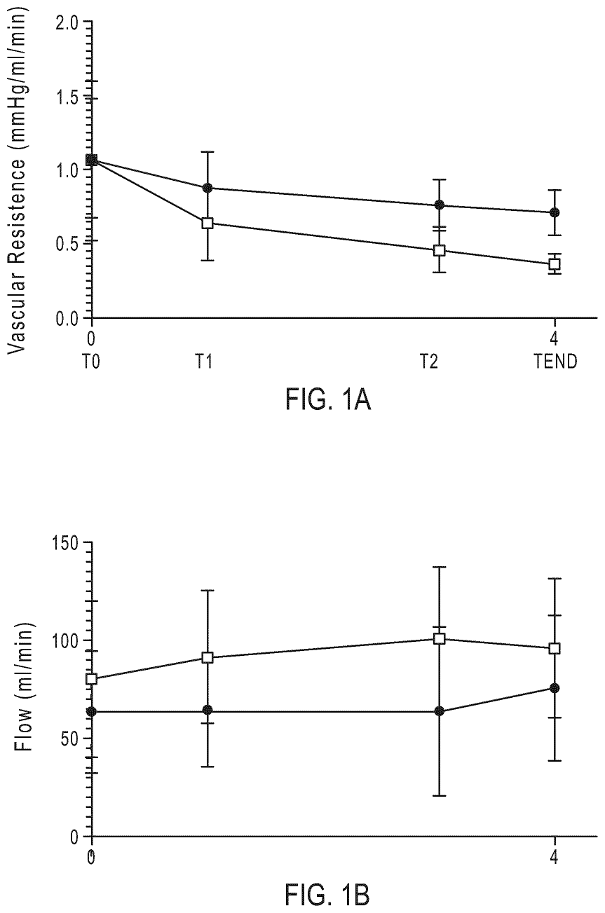

Improvements in renal vascular resistance parameters were observed in explanted kidneys preserved with PumpProtect® solution supplemented with CER-001 relative to explanted kidneys preserved with PumpProtect® solution not supplemented with CER-001 (FIG. 1A-1B).

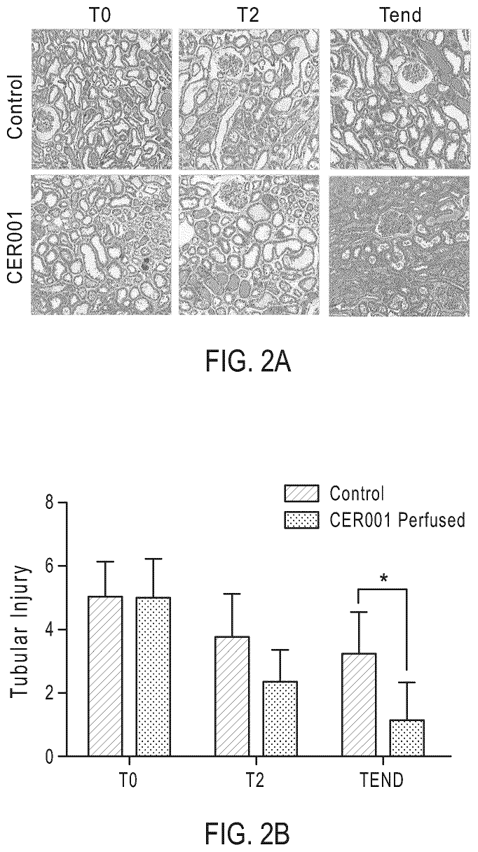

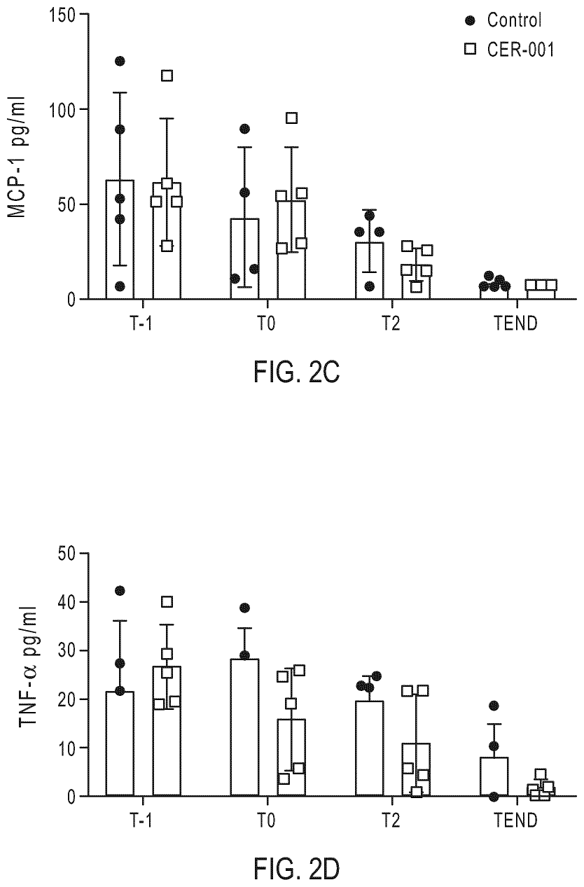

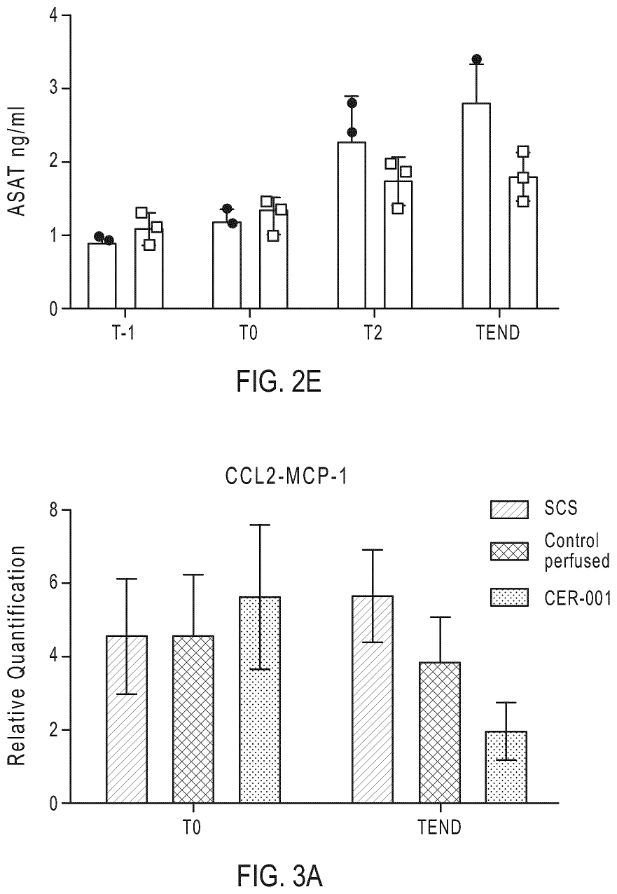

Histological analysis showed typical changes of renal morphology of porcine kidneys after cardiac death. These changes included loss of tubular brush border, tubular cells vacuolization and dilatation and became more evident after overnight static cold storage (SCS) (FIG. 2A, TO). The HMP treatment with conventional PumpProtect® solution partially preserved renal physiological morphology and reduced injury (FIG. 2A, control). However, the HMP treatment with CER-001 supplemented solution significantly improved renal tissue with reduction of swelling and tubular epithelial cells necrosis/apoptosis, decreased flattened epithelium, reduced edema and overall improvement of renal tissue (FIG. 2A, “CER001”).

Tubular injury was reduced in kidneys preserved with PumpProtect® solution supplemented with CER-001 relative to explanted kidneys preserved with PumpProtect® solution not supplemented with CER-001 (FIG. 2B). Perfusate analysis of inflammatory cytokines revealed reduced MCP-1 and TNF-α levels after HMP treatment in CER-001 supplemented preservation solution compared to non-supplemented solution (FIGS. 2C-2D). Aspartate aminotransferase levels (evaluated as marker of renal injury) were reduced at T2 and T_{end} for kidneys preserved with PumpProtect® solution supplemented with CER-001 relative to explanted kidneys preserved with PumpProtect® solution not supplemented with CER-001 (FIG. 2E).

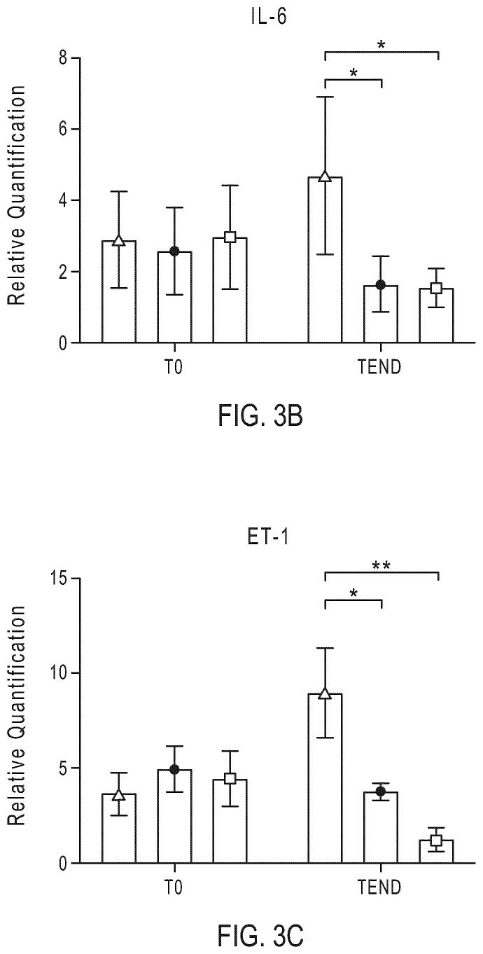

CCL2 (MCP-1), IL-6 and ET-1 gene expression in kidneys perfused with CER-001 supplemented PumpProtect® solution was decreased compared to kidneys perfused with non-supplemented solution (FIG. 3A-3C).

### 7.5. Example 5: In Vitro Evaluation of the Efficacy of CER-001 to Protect Human Endothelial Cells

The aim of this in vitro study was to evaluate the molecular mechanisms of CER-001 protection on endothelial cells.

In endothelial cells, phosphorylation of eNOS at Ser-1177 regulates in vivo NO generation, altering both the Ca²⁺ sensitivity of the enzyme and rate of NO formation, with protective anti-apoptotic, anti-oxidative and anti-inflammatory effects. Normally, phosphorylation of eNOS at Ser-1177 is stimulated by vascular endothelial growth factor (VEGF). Phosphorylation of Thr-495 indirectly affects this process through regulation of the calmodulin and caveolin interaction (Chen et al., 2008, J Biol Chem. 283(40):27038-27047).

In this study, human endothelial cells (HUVEC) were grown in EndoGro medium, then incubated with (i) C5a at 10⁻⁷ nM for 60 minutes, (ii) LPS at 4 μg/ml for 60 minutes (iii) CER-001 (range 5-100 μg/ml) for 60 minutes, or (iv) C5a at 10⁻⁷ nM for 30 minutes and then CER-001 for 30 minutes. HUVEC cells incubated with VEGF at 50 ng/ml for 60 minutes were used as a positive control of phosphorylation of eNOS at Ser-1177. Ser 1177-eNOS phosphorylation was analyzed by FACS.

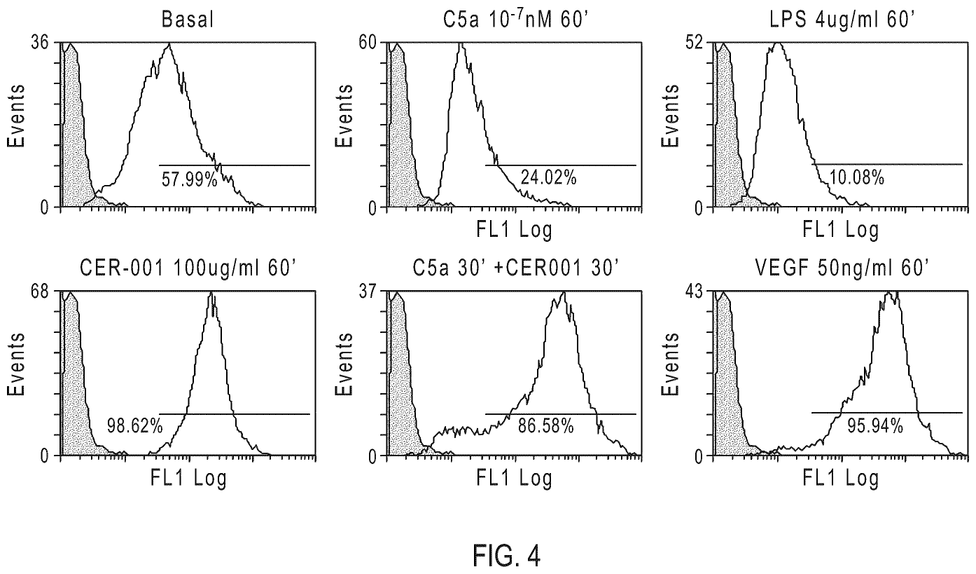

CER-001 reduced endothelial cell dysfunction after C5a stimulation (FIG. 4). Compared to the untreated condition (basal), both C5a and LPS induced a significant decrease of phosphoSer1177-eNOS, whereas CER-001 increased phosphoSer1177-eNOS levels. Endothelial cells exposed to C5a for 30 minutes and then to CER-001 for other 30 minutes showed restored phosphoSer1177-eNOS levels compared to the C5a condition, indicating a protective role of CER-001.

### 7.6. Example 6: Use of CER-001 in Ex-Vivo Normothermic Machine Perfusion to Improve Kidney Quality

Kidneys were subjected to normothermic machine perfusion (NMP) with a conventional organ preservation solution or with a conventional organ preservation solution supplemented with CER-001.

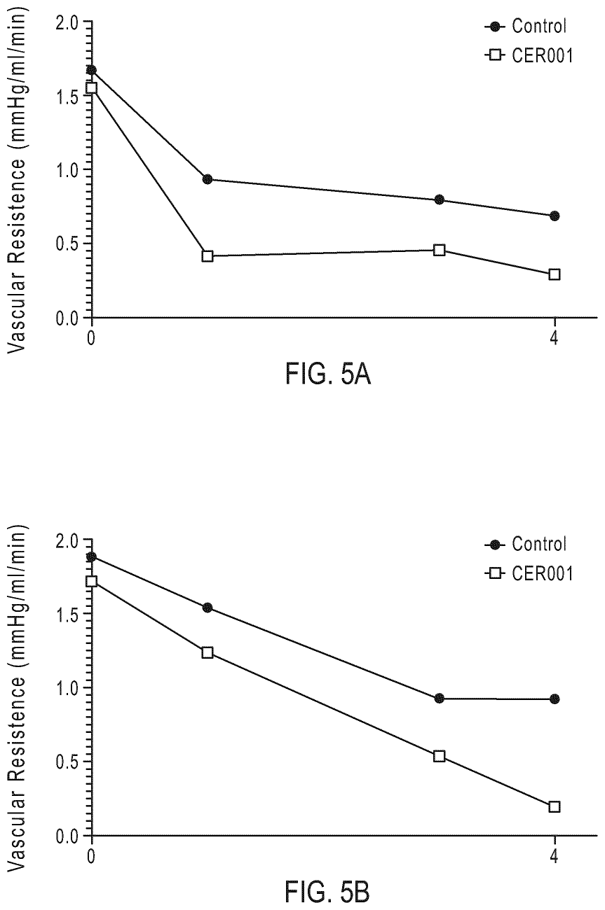

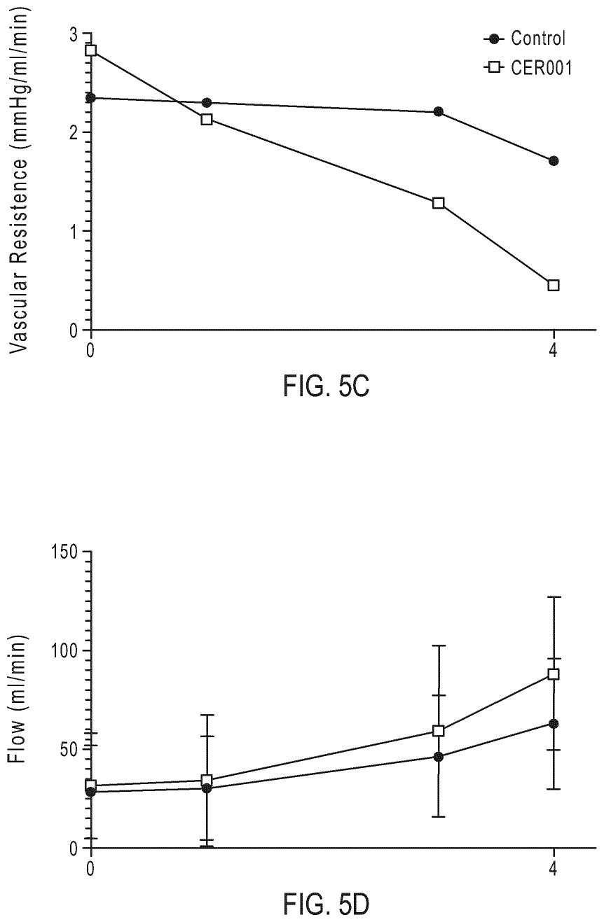

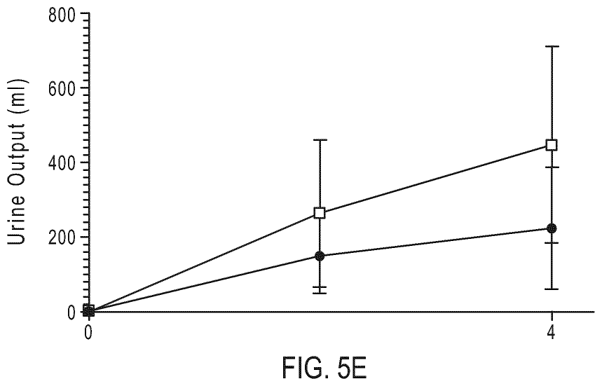

Results are shown in FIGS. 5A-5E. Significant improvements were observed in vascular renal resistance (FIGS. 5A-5C) and renal flow (FIG. 5D) of NMP-perfused kidneys perfused with conventional solution supplemented with CER-001 compared to NMP-perfused kidneys perfused with conventional solution not supplemented with CER-001. Urine output showed increased levels in kidneys perfused with CER-001 supplemented solutions (FIG. 5E).

### 8. SPECIFIC EMBODIMENTS

Various aspects of the present disclosure are described in the embodiments set forth in the following numbered paragraphs.

1. A lipid binding protein-based complex for use in an organ preservation solution.

2. The lipid binding protein-based complex for use according to embodiment 1, which is a reconstituted HDL or HDL mimetic.

3. The lipid binding protein-based complex for use according to embodiment 1 or embodiment 2, which comprises a sphingomyelin.

4. The lipid binding protein-based complex for use according to any one of embodiments 1 to 3, which comprises a negatively charged lipid.

5. The lipid binding protein-based complex for use according to embodiment 4, wherein the negatively charged lipid is 1,2-dipalmitoyl-sn-glycero-3-[phospho-rac-(1-glycerol) (DPPG) or a salt thereof.

6. The lipid binding protein-based complex for use according to embodiment 2, which is CER-001, CSL-111, CSL-112, CER-522 or ETC-216.

7. The lipid binding protein-based complex for use according to embodiment 6, which is CER-001.

8. The lipid binding protein-based complex for use according to embodiment 7, wherein the CER-001 is a lipoprotein complex comprising ApoA-I and phospholipids in a ApoA-I weight:total phospholipid weight ratio of 1:2.7+/−20% and the phospholipids sphingomyelin and DPPG in a sphingomyelin:DPPG weight:weight ratio of 97:3+/−20%.

9. The lipid binding protein-based complex for use according to embodiment 7, wherein the CER-001 is a lipoprotein complex comprising ApoA-I and phospholipids in a ApoA-I weight:total phospholipid weight ratio of 1:2.7+/−10% and the phospholipids sphingomyelin and DPPG in a sphingomyelin: DPPG weight:weight ratio of 97:3+/−10%.

10. The lipid binding protein-based complex for use according to embodiment 7, wherein the CER-001 is a lipoprotein complex comprising ApoA-I and phospholipids in a ApoA-I weight:total phospholipid weight ratio of 1:2.7 and the phospholipids sphingomyelin and DPPG in a sphingomyelin:DPPG weight:weight ratio of 97:3.

11. The lipid binding protein-based complex for use according to any one of embodiments 7 to 10, wherein the ApoA-I has the amino acid sequence of amino acids 25-267 of SEQ ID NO:1 of WO 2012/109162.

12. The lipid binding protein-based complex for use according to any one of embodiments 7 to 11, wherein the ApoA-I is recombinantly expressed.

13. The lipid binding protein-based complex for use according to any one of embodiments 7 to 12, wherein the CER-001 comprises natural sphingomyelin.

14. The lipid binding protein-based complex for use according to embodiment 13, wherein the natural sphingomyelin is chicken egg sphingomyelin.

15. The lipid binding protein-based complex for use according to any one of embodiments 7 to 14, wherein the CER-001 comprises synthetic sphingomyelin.

16. The lipid binding protein-based complex for use according to embodiment 15, wherein the synthetic sphingomyelin is palmitoylsphingomyelin.

17. The lipid binding protein-based complex for use according to any one of embodiments 7 to 16, wherein CER-001 is at least 95% homogeneous.

18. The lipid binding protein-based complex for use according to any one of embodiments 7 to 17, wherein CER-001 is at least 97% homogeneous.

19. The lipid binding protein-based complex for use according to any one of embodiments 7 to 18, wherein CER-001 is at least 98% homogeneous.

20. The lipid binding protein-based complex for use according to any one of embodiments 7 to 19, wherein CER-001 is at least 99% homogeneous.

21. The lipid binding protein-based complex for use according to any one of embodiments 1 to 5, which is an Apomer or a Cargomer.

22. An organ preservation solution comprising the lipid binding protein-based complex according to any one of embodiments 1 to 21.

23. An organ preservation solution comprising a lipid binding protein-based complex.

24. The organ preservation solution of embodiment 23, wherein the lipid binding protein-based complex is a reconstituted HDL or HDL mimetic.

25. The organ preservation solution of embodiment 23 or embodiment 24, wherein the lipid binding protein-based complex comprises a sphingomyelin.

26. The organ preservation solution of any one of embodiments 23 to 25, wherein the lipid binding protein-based complex comprises a negatively charged lipid.

27. The organ preservation solution of embodiment 26, wherein the negatively charged lipid is 1,2-dipalmitoyl-sn-glycero-3-[phospho-rac-(1-glycerol) (DPPG) or a salt thereof.

28. The organ preservation solution of embodiment 24, wherein the lipid binding protein-based complex is CER-001, CSL-111, CSL-112, CER-522 or ETC-216.

29. The organ preservation solution of embodiment 28, wherein the lipid binding protein-based complex is CER-001.

30. The organ preservation solution of embodiment 29, wherein the CER-001 is a lipoprotein complex comprising ApoA-I and phospholipids in a ApoA-I weight:total phospholipid weight ratio of 1:2.7+/−20% and the phospholipids sphingomyelin and DPPG in a sphingomyelin:DPPG weight:weight ratio of 97:3+/−20%.

31. The organ preservation solution of embodiment 29, wherein the CER-001 is a lipoprotein complex comprising ApoA-I and phospholipids in a ApoA-I weight:total phospholipid weight ratio of 1:2.7+/−10% and the phospholipids sphingomyelin and DPPG in a sphingomyelin:DPPG weight:weight ratio of 97:3+/−10%.

32. The organ preservation solution of embodiment 29, wherein the CER-001 is a lipoprotein complex comprising ApoA-I and phospholipids in a ApoA-I weight:total phospholipid weight ratio of 1:2.7 and the phospholipids sphingomyelin and DPPG in a sphingomyelin: DPPG weight:weight ratio of 97:3.

33. The organ preservation solution of any one of embodiments 29 to 32, wherein the ApoA-I has the amino acid sequence of amino acids 25-267 of SEQ ID NO:1 of WO 2012/109162.

34. The organ preservation solution of any one of embodiments 29 to 33, wherein the ApoA-I is recombinantly expressed.

35. The organ preservation solution of any one of embodiments 29 to 34, wherein the CER-001 comprises natural sphingomyelin.

36. The organ preservation solution of embodiment 35, wherein the natural sphingomyelin is chicken egg sphingomyelin.

37. The organ preservation solution of any one of embodiments 29 to 36, wherein the CER-001 comprises synthetic sphingomyelin.

38. The organ preservation solution of embodiment 37, wherein the synthetic sphingomyelin is palmitoylsphingomyelin.

39. The organ preservation solution of any one of embodiments 29 to 38, wherein CER-001 is at least 95% homogeneous.

40. The organ preservation solution of any one of embodiments 29 to 39, wherein CER-001 is at least 97% homogeneous.

41. The organ preservation solution of any one of embodiments 29 to 40, wherein CER-001 is at least 98% homogeneous.

42. The organ preservation solution of any one of embodiments 29 to 41, wherein CER-001 is at least 99% homogeneous.

43. The organ preservation solution of any one of embodiments 23 to 27, wherein the lipid binding protein-based complex is an Apomer or a Cargomer.

44. The organ preservation solution of any one of embodiments 22 to 43, which comprises a buffer, an antioxidant, a nutrient and/or metabolic substrate, an electrolyte, a colloid, an impermeant, a gas, or a combination thereof.

45. The organ preservation solution of embodiment 44, which comprises a buffer, optionally wherein the buffer comprises a borate, borate-polyol complex, succinate, phosphate buffering agent, citrate buffering agent, acetate buffering agent, carbonate buffering agent, organic buffering agent, amino acid buffering agent such as histidine, or a combination thereof.

46. The organ preservation solution of embodiment 44 or embodiment 45, which comprises an antioxidant, optionally wherein the antioxidant comprises Ilopurinol, reduced glutathione, a ROS-scavenging amino acid such as tryptophan or I-arginine or histidine, lecithinized superoxide dismutase (lec-SOD), H₂S, N-acetylcysteine, propofol, TMZ, rh-BMP-7, trolox, edaravone, selenium, nicaraven, prostaglandin E1, tanshinone IIA or a combination thereof.

47. The organ preservation solution of any one of embodiments 44 to 46, which comprises a nutrient and/or metabolic substrate, optionally wherein the nutrient and/or metabolic substrate comprises an amino acid such as tryptophan, glutamic acid, histidine, I-arginine, N-acetylcysteine, d-cysteine, or a combination thereof.

48. The organ preservation solution of any one of embodiments 44 to 47, which comprises an electrolyte, optionally wherein the electrolyte comprises Na⁺, K⁺, Mg²⁺, Ca²⁺, Cl⁻, SO₄²⁻, PO₄³⁻, HCO³⁻, citrate or a combination thereof.

49. The organ preservation solution of any one of embodiments 44 to 48, which comprises a colloid, optionally wherein the colloid is Hydroxyethyl starch (HES) (e.g., 50 kDa), Dextran (e.g., 40 kDa), Poly-ethylene glycol (PEG) such as PEG 35 (35 kDa) or PEG 20 (20 kDa), or a combination thereof.

50. The organ preservation solution of any one of embodiments 44 to 49, which comprises an impermeant, optionally wherein the impermeant is a monosaccharide such as glucose, mannitol, sucrose, raffinose, lactobionate or a combination thereof.

51. The organ preservation solution of any one of embodiments 44 to 50, which comprises a gas, optionally wherein the gas is oxygen (O₂), hydrogen (H₂), carbon monoxide (CO), nitric oxide (NO), hydrogen sulfide (H₂S), argon (Ar), or a combination thereof.

52. The organ preservation solution of embodiment 44, which comprises one or more components of Celsior® solution, EC solution, UW solution, HTK solution, IGL-1® solution, or HC-A solution (as set forth in Table 2). 53. The organ preservation solution of embodiment 45, which comprises the components of Celsior® solution, EC solution, UW solution, HTK solution, IGL-1® solution, or HC-A solution (as set forth in Table 2).

54. The organ preservation solution of embodiment 53, which comprises the components of Celsior® solution, EC solution, UW solution, HTK solution, IGL-1® solution, or HC-A solution (as set forth in Table 2) at the concentrations set forth in Table 2±20%.

55. The organ preservation solution of embodiment 53, which comprises the components of Celsior® solution, EC solution, UW solution, HTK solution, IGL-1® solution, or HC-A solution (as set forth in Table 2) at the concentrations set forth in Table 2±15%.

56. The organ preservation solution of embodiment 53, which comprises the components of Celsior® solution, EC solution, UW solution, HTK solution, IGL-1® solution, or HC-A solution (as set forth in Table 2) at the concentrations set forth in Table 2±10%.

57. The organ preservation solution of embodiment 53, which comprises the components of Celsior® solution, EC solution, UW solution, HTK solution, IGL-1® solution, or HC-A solution (as set forth in Table 2) at the concentrations set forth in Table 2±5%.

58. The organ preservation solution of any one of embodiments 53 to 57, which comprises the components of Celsior® solution (as set forth in Table 2).

59. The organ preservation solution of embodiment 44, which comprises one or more components of PumpProtect® solution (as set forth in Section 6.2).

60. The organ preservation solution of embodiment 59, which comprises the components of PumpProtect® solution (as set forth in Section 6.2).

61. The organ preservation solution of embodiment 60, which comprises the components of PumpProtect® solution (as set forth in Section 6.2) at the concentrations set forth in Section 6.2±20%, ±15%, ±10%, or ±5%.

62. The organ preservation solution of any one of embodiments 22 to 61, which comprises the lipid binding protein-based complex at a concentration of 0.1 mg/ml to 5 mg/ml (e.g., 0.3 mg/ml to 0.5 mg/ml, 0.2 mg/ml to 0.6 mg/ml, 0.1 mg/ml to 1 mg/ml, 1 mg/ml to 2 mg/ml, or 2 mg/ml to 5 mg/ml).

63. The organ preservation solution of any one of embodiments 22 to 61, which comprises the lipid binding protein-based complex at a concentration of 0.4 mg/ml.

64. A kit comprising a lipid binding protein-based complex and one or more components of an organ preservation solution, optionally wherein the lipid binding protein-based complex is as defined in any one of embodiments 1 to 21.

65. The kit of embodiment 64, wherein the one or more components of an organ preservation solution comprise a buffer, an antioxidant, a nutrient and/or metabolic substrate, an electrolyte, a colloid, an impermeant, a gas, or a combination thereof.

66. The kit of embodiment 65, wherein the one or more components of an organ preservation solution comprise one or more components of Celsior® solution, EC solution, UW solution, HTK solution, IGL-1® solution, or HC-A solution (as set forth in Table 2).

67. The kit of embodiment 66, wherein the one or more components of an organ preservation solution comprise the components of Celsior® solution, EC solution, UW solution, HTK solution, IGL-1® solution, or HC-A solution (as set forth in Table 2).

68. The kit of embodiment 67, which comprises the components of Celsior® solution, EC solution, UW solution, HTK solution, IGL-1® solution, or HC-A solution (as set forth in Table 2) at the concentrations set forth in Table 2±20%.

69. The kit of embodiment 67, which comprises the components of Celsior® solution, EC solution, UW solution, HTK solution, IGL-1® solution, or HC-A solution (as set forth in Table 2) at the concentrations set forth in Table 2±15%.

70. The kit of embodiment 67, which comprises the components of Celsior® solution, EC solution, UW solution, HTK solution, IGL-1® solution, or HC-A solution (as set forth in Table 2) at the concentrations set forth in Table 2±10%.

71. The kit of embodiment 67, which comprises the components of Celsior® solution, EC solution, UW solution, HTK solution, IGL-1® solution, or HC-A solution (as set forth in Table 2) at the concentrations set forth in Table 2±5%.

72. The kit of any one of embodiments 67 to 71, wherein the one or more components of an organ preservation solution comprise the components of Celsior® solution (as set forth in Table 2).

73. The kit of embodiment 65, wherein the one or more components of an organ preservation solution comprise one or more components of PumpProtect® solution (as set forth in Section 6.2).

74. The kit of embodiment 73, which comprises the components of PumpProtect® solution (as set forth in Section 6.2).

75. The kit of embodiment 74, which comprises the components of PumpProtect® solution (as set forth in Section 6.2) at the concentration set forth in Section 6.2±20%, ±15%, ±10%, or ±5%.

76. The kit of any one of embodiments 64 to 75, wherein the kit comprises a solution containing the one or more components of an organ preservation solution.

77. The kit of any one of embodiments 64 to 76, wherein the kit comprises a solution of the lipid binding protein-based complex.

78. The kit of any one of embodiments 64 to 76, wherein the kit comprises the lipid binding protein-based complex in lyophilized form.

79. A process for preparing an organ preservation solution from the kit of any one of embodiments 64 to 78, comprising combining the lipid binding protein-based complex and the one or more components of an organ preservation solution.

80. A process for preparing an organ preservation solution comprising combining a lipid binding protein-based complex and one or more components of an organ preservation solution, optionally wherein the lipid binding protein-based complex is as defined in any one of embodiments 1 to 21.

81. The process of embodiment 80, wherein the one or more components of an organ preservation solution comprise a buffer, an antioxidant, a nutrient and/or metabolic substrate, an electrolyte, a colloid, an impermeant, a gas, or a combination thereof.

82. The process of embodiment 81, wherein the one or more components of an organ preservation solution comprise one or more components of Celsior® solution, EC solution, UW solution, HTK solution, IGL-1® solution, or HC-A solution (as set forth in Table 2).

83. The process of embodiment 82, wherein the one or more components of an organ preservation solution comprise the components of Celsior® solution, EC solution, UW solution, HTK solution, IGL-1® solution, or HC-A solution (as set forth in Table 2).

84. The process of embodiment 83, wherein the components of Celsior® solution, EC solution, UW solution, HTK solution, IGL-1® solution, or HC-A solution (as set forth in Table 2) are at the concentrations set forth in Table 2±20%.

85. The process of embodiment 83, wherein the components of Celsior® solution, EC solution, UW solution, HTK solution, IGL-1® solution, or HC-A solution (as set forth in Table 2) are at the concentrations set forth in Table 2±15%.

86. The process of embodiment 83, wherein the components of Celsior® solution, EC solution, UW solution, HTK solution, IGL-1® solution, or HC-A solution (as set forth in Table 2) are at the concentrations set forth in Table 2±10%.

87. The process of embodiment 83, wherein the components of Celsior® solution, EC solution, UW solution, HTK solution, IGL-1® solution, or HC-A solution (as set forth in Table 2) are at the concentrations set forth in Table 2±5%.

88. The process of any one of embodiments 83 to 87, wherein the one or more components of an organ preservation solution comprise the components of Celsior® solution (as set forth in Table 2).

89. The process of embodiment 81, wherein the one or more components of an organ preservation solution comprise one or more components of PumpProtect® solution (as set forth in Section 6.2).

90. The process of embodiment 89, wherein the one or more components of an organ preservation solution comprise the components of PumpProtect® solution (as set forth in Section 6.2).

91. The process of embodiment 90, wherein the one or more components of an organ preservation solution comprise the components of PumpProtect® solution (as set forth in Section 6.2) at the concentration set forth in Section 6.2±20%, ±15%, ±10%, or ±5%.

92. An organ preservation solution produced by the process of any one of embodiments 80 to 91.

93. An organ preservation solution product comprising the organ preservation solution of any one of embodiments 22 to 63 and 92 in a sealed container.

94. The organ preservation solution product of embodiment 93, wherein the container is a bag.

95. The organ preservation solution product of embodiment 93 or embodiment 94, wherein the container comprises 1 L of the organ preservation solution.

96. A system comprising (a) the organ preservation solution of any one of embodiments 22 to 63 and 92 or the organ preservation solution product of any one of embodiments 93 to 95 and (b) a perfusion machine and/or an organ.

97. The system of embodiment 96, which comprises a perfusion machine.

98. The system of embodiment 97, wherein the perfusion machine is a heart-lung machine.

99. The system of any one of embodiments 96 to 98, which comprises an organ.

100. The system of embodiment 99, wherein the organ is a kidney, a liver, a heart, a lung, pancreas, intestine, or trachea.

101. The system of embodiment 100, wherein the organ is a kidney.

102. The system of any one of embodiments 96 to 101, wherein the organ is from a mammal.

103. The system of embodiment 102, wherein the mammal is a human or pig.

104. The system of embodiment 103, wherein the mammal is a human.

105. The system of embodiment 103, wherein the mammal is a pig.

106. A system comprising (a) the organ preservation solution of any one of embodiments 22 to 63 and 92 or the organ preservation solution product of any one of embodiments 93 to 95 and (b) a tissue.

107. The system of embodiment 106, wherein the tissue is eye, skin, fat, muscle, bone, cartilage, fetal thymus, or nerve tissue.

108. The system of embodiment 107, wherein the tissue is cornea tissue.

109. The system of any one of embodiments 106 to 108, wherein the tissue is from a mammal.

110. The system of embodiment 109, wherein the mammal is a human or pig.

111. The system of embodiment 110, wherein the mammal is a human.

112. The system of embodiment 110, wherein the mammal is a pig.

113. A process for ex-vivo organ preservation, comprising contacting a donor organ with the organ preservation solution of any one of embodiments 22 to 63 and 92.

114. The process of embodiment 113, which comprises subjecting the organ to machine perfusion with the organ preservation solution.

115. The process of embodiment 114, which comprises subjecting the organ to machine perfusion with the organ preservation solution for up to two days.

116. The process of embodiment 114, which comprises subjecting the organ to machine perfusion with the organ preservation solution for up to 36 hours.

117. The process of embodiment 114, which comprises subjecting the organ to machine perfusion with the organ preservation solution for up to one day.

118. The process of embodiment 114, which comprises subjecting the organ to machine perfusion with the organ preservation solution for up to 12 hours.

119. The process of any one of embodiments 114 to 118, which comprises subjecting the organ to machine perfusion with the organ preservation solution for at least one hour.

120. The process of any one of embodiments 114 to 118, which comprises subjecting the organ to machine perfusion with the organ preservation solution for at least two hours.

121. The process of any one of embodiments 114 to 118, which comprises subjecting the organ to machine perfusion with the organ preservation solution for at least four hours.

122. The process of any one of embodiments 114 to 118, which comprises subjecting the organ to machine perfusion with the organ preservation solution for at least six hours.

123. The process of any one of embodiments 114 to 122, wherein the machine perfusion is performed using the system of any one of embodiments 96 to 105.

124. The process of any one of embodiments 113 to 123, wherein the organ preservation solution is diluted with whole blood.

125. The process of embodiment 124, wherein the volume:volume ratio of organ preservation solution to whole blood is 1:1 to 1:3.

126. The process of any one of embodiments 113 to 123, wherein the organ preservation solution is not diluted.

127. The process of any one of embodiments 114 to 126, wherein the machine perfusion is normothermic, optionally from 30° C. to 38° C.

128. The process of any one of embodiments 114 to 126, wherein the machine perfusion is from 8° C. to 25° C., optionally from 20° C. to 25° C.

129. The process of any one of embodiments 114 to 126, wherein the machine perfusion is subnormothermic, optionally from 2° C. to 8° C.

130. The process of any one of embodiments 114 to 129, which comprises flushing the organ with the organ preservation solution prior to the machine perfusion, optionally wherein the organ preservation solution is 2° C. to 8° C. prior to flushing the organ.

131. The process of any one of embodiments 114 to 130, which further comprises cold storage of the organ before and/or after the machine perfusion, optionally at 2° C. to 6° C.

132. The process of embodiment 113, which comprises cold storage of the organ in the absence of machine perfusion, optionally at 2° C. to 6° C.

133. The process of embodiment 131 or 132, which comprises cold storage of the organ in the organ preservation solution for up to one week.

134. The process of embodiment 131 or 132, which comprises cold storage of the organ in the organ preservation solution for up to five days.

135. The process of embodiment 131 or 132, which comprises cold storage of the organ in the organ preservation solution for up to four days.

136. The process of embodiment 131 or 132, which comprises cold storage of the organ in the organ preservation solution for up to three days.

137. The process of embodiment 131 or 132, which comprises cold storage of the organ in the organ preservation solution for up to two days.

138. The process of embodiment 131 or 132, which comprises cold storage of the organ in the organ preservation solution for up to 36 hours.

139. The process of embodiment 131 or 132, which comprises cold storage of the organ in the organ preservation solution for up to one day.

140. The process of embodiment 131 or 132, which comprises cold storage of the organ in the organ preservation solution for up to 12 hours.

141. The process of any one of embodiments 131 to 140, which comprises cold storage of the organ in the organ preservation solution for at least one hour.

142. The process of any one of embodiments 131 to 140, which comprises cold storage of the organ in the organ preservation solution for at least two hours.

143. The process of any one of embodiments 131 to 140, which comprises cold storage of the organ in the organ preservation solution for at least four hours.

144. The process of any one of embodiments 131 to 140, which comprises cold storage of the organ in the organ preservation solution for at least six hours.

145. The process of any one of embodiments 113 to 144, which comprises flushing the organ with the organ preservation solution, which is optionally at 2° C. to 8° C. or 2° C. to 6° C., before and/or after removal of the organ from the donor.

146. The process of embodiment 145, wherein the organ preservation solution is left in the organ vasculature during hypothermic storage and/or transportation.

147. The process of any one of embodiments 113 to 146, wherein the organ is a kidney, a liver, a heart, a lung, pancreas, intestine, or trachea.

148. The process of embodiment 147, wherein the organ is a kidney.

149. The process of any one of embodiments 113 to 148, wherein the organ is from a mammal.

150. The process of embodiment 149, wherein the mammal is a human or pig.

151. The process of embodiment 150, wherein the mammal is a human.

152. The process of embodiment 150, wherein the mammal is a pig.

153. The process of any one of embodiments 113 to 152, further comprising removing the organ from the organ donor.

154. An organ obtained by the process of any one of embodiments 113 to 153.

155. A method for transplanting an organ, comprising transplanting the organ of embodiment 154 into a subject in need thereof.

156. A process for ex-vivo tissue preservation, comprising contacting a donor tissue with the organ preservation solution of any one of embodiments 22 to 63 and 92.

157. The process of embodiment 156, which comprises storage of the tissue in the organ preservation solution.

158. The process of embodiment 156, which comprises normothermic storage of the tissue in the organ preservation solution, optionally from 30° C. to 38° C.

159. The process of embodiment 156, which comprises cold storage of the tissue in the organ preservation solution, optionally at 2° C. to 6° C.

160. The process of any one of embodiments 157 to 159, which comprises storing the tissue in the organ preservation solution for up to 4 weeks.

161. The process of any one of embodiments 157 to 159, which comprises storing the tissue in the organ preservation solution for up to 2 weeks.

162. The process of any one of embodiments 157 to 159, which comprises storing the tissue in the organ preservation solution for up to 1 week.

163. The process of any one of embodiments 157 to 159, which comprises storing the tissue in the organ preservation solution for up to four days.

164. The process of any one of embodiments 157 to 159, which comprises storing the tissue in the organ preservation solution for up to two days.

165. The process of any one of embodiments 157 to 159, which comprises storing the tissue in the organ preservation solution for up to 36 hours.

166. The process of any one of embodiments 157 to 159, which comprises storing the tissue in the organ preservation solution for up to one day.

167. The process of any one of embodiments 157 to 159, which comprises storing the tissue in the organ preservation solution for up to 12 hours.

168. The process of any one of embodiments 157 to 167, which comprises storing the tissue in the organ preservation solution for at least one hour.

169. The process of any one of embodiments 157 to 167, which comprises storing the tissue in the organ preservation solution for at least two hours.

170. The process of any one of embodiments 157 to 167, which comprises storing the tissue in the organ preservation solution for at least four hours.

171. The process of any one of embodiments 157 to 167, which comprises storing the tissue in the organ preservation solution for at least six hours.

172. The process of any one of embodiments 156 to 171, wherein the tissue is eye, skin, fat, muscle, bone, cartilage, fetal thymus, or nerve tissue.

173. The process of embodiment 172, wherein the tissue is cornea tissue.

174. The process of any one of embodiments 156 to 173, wherein the tissue is from a mammal.

175. The process of embodiment 174, wherein the mammal is a human or pig.

176. The process of embodiment 175, wherein the mammal is a human.

177. The process of embodiment 175, wherein the mammal is a pig.

178. The process of any one of embodiments 156 to 177, further comprising removing the tissue from the tissue donor.

179. A tissue obtained by the process of any one of embodiments 156 to 179.

180. A method for transplanting a tissue, comprising transplanting the tissue of embodiment 179 to a subject in need thereof.

181. A transplantation method comprising:
a. obtaining a donor organ;
b. contacting the donor organ with the organ preservation solution of any one of embodiments 22 to 63 and 92, wherein the contacting comprises:
   i. machine perfusion of the organ with the organ preservation solution; or
   ii. cold storage of the organ in the organ preservation solution; and
c. transplanting the organ into a subject in need of an organ transplant.

182. The method of embodiment 181, wherein the donor organ is a kidney, a liver, a heart, a lung, pancreas, intestine, or trachea.

183. The method of embodiment 181 or embodiment 182, wherein the contacting comprises machine perfusion or cold storage of the organ with the organ preservation solution for at least one hour and/or up to 1 week.

184. A transplantation method comprising:
a. obtaining a donor tissue;
b. storing the donor tissue in the organ preservation solution of any one of embodiments 22 to 63 and 92, and
c. transplanting the tissue to a subject in need of a tissue transplant.

185. The method of embodiment 184, wherein the donor tissue is eye, skin, fat, muscle, bone, cartilage, fetal thymus, or nerve tissue.

186. The method of embodiment 184 or embodiment 185, wherein the storing comprises storing the tissue with the organ preservation solution for at least one hour and/or up to 4 weeks.

While various specific embodiments have been illustrated and described, it will be appreciated that various changes can be made without departing from the spirit and scope of the disclosure(s)

### 9. INCORPORATION BY REFERENCE

All publications, patents, patent applications and other documents cited in this application are hereby incorporated by reference in their entireties for all purposes to the same extent as if each individual publication, patent, patent application or other document were individually indicated to be incorporated by reference for all purposes.

Any discussion of documents, acts, materials, devices, articles or the like that has been included in this specification is solely for the purpose of providing a context for the present disclosure. It is not to be taken as an admission that any or all of these matters form part of the prior art base or were common general knowledge in the field relevant to the present disclosure as it existed anywhere before the priority date of this application.

What is claimed is:

1. A lipid binding protein-based complex for use in an organ preservation solution.

2. The lipid binding protein-based complex for use according to claim 1, which is a reconstituted HDL or HDL mimetic.

3. The lipid binding protein-based complex for use according to claim 1 or claim 2, which comprises a sphingomyelin.

4. The lipid binding protein-based complex for use according to any one of claims 1 to 3, which comprises a negatively charged lipid.

5. The lipid binding protein-based complex for use according to claim 4, wherein the negatively charged lipid is 1,2-dipalmitoyl-sn-glycero-3-[phospho-rac-(1-glycerol) (DPPG) or a salt thereof.

6. The lipid binding protein-based complex for use according to claim 2, which is CER-001, CSL-111, CSL-112, CER-522 or ETC-216.

7. The lipid binding protein-based complex for use according to claim 6, which is CER-001.

8. The lipid binding protein-based complex for use according to any one of claims 1 to 5, which is an Apomer or a Cargomer.

9. An organ preservation solution comprising the lipid binding protein-based complex according to any one of claims 1 to 8.

10. An organ preservation solution comprising a lipid binding protein-based complex.

11. The organ preservation solution of claim 10, wherein the lipid binding protein-based complex is a reconstituted HDL or HDL mimetic.

12. The organ preservation solution of claim 10 or claim 11, wherein the lipid binding protein-based complex comprises a sphingomyelin.

13. The organ preservation solution of any one of claims 10 to 12, wherein the lipid binding protein-based complex comprises a negatively charged lipid.

14. The organ preservation solution of claim 13, wherein the negatively charged lipid is 1,2-dipalmitoyl-sn-glycero-3-[phospho-rac-(1-glycerol) (DPPG) or a salt thereof.

15. The organ preservation solution of claim 11, wherein the lipid binding protein-based complex is CER-001, CSL-111, CSL-112, CER-522 or ETC-216.

16. The organ preservation solution of claim 15, wherein the lipid binding protein-based complex is CER-001.

17. The organ preservation solution of any one of claims 10 to 14, wherein the lipid binding protein-based complex is an Apomer or a Cargomer.

18. The organ preservation solution of any one of claims 9 to 17, which comprises a buffer, an antioxidant, a nutrient and/or metabolic substrate, an electrolyte, a colloid, an impermeant, a gas, or a combination thereof.

19. The organ preservation solution of claim 18, which comprises one or more components of Celsior® solution, EC solution, UW solution, HTK solution, IGL-1® solution, or HC-A solution (as set forth in Table 2).

20. The organ preservation solution of claim 19, which comprises the components of Celsior® solution (as set forth in Table 2).

21. The organ preservation solution of any one of claims 9 to 20, which comprises the lipid binding protein-based complex at a concentration of 0.1 mg/ml to 5 mg/ml.

22. The organ preservation solution of any one of claims 9 to 20, which comprises the lipid binding protein-based complex at a concentration of 0.4 mg/ml.

23. A kit comprising a lipid binding protein-based complex and one or more components of an organ preservation solution, optionally wherein the lipid binding protein-based complex is as defined in any one of claims 1 to 8.

24. The kit of claim 23, wherein the one or more components of an organ preservation solution comprise a buffer, an antioxidant, a nutrient and/or metabolic substrate, an electrolyte, a colloid, an impermeant, a gas, or a combination thereof.

25. The kit of claim 24, wherein the one or more components of an organ preservation solution comprise one or more components of Celsior® solution, EC solution, UW solution, HTK solution, IGL-1® solution, or HC-A solution (as set forth in Table 2).

26. A process for preparing an organ preservation solution from the kit of any one of claims 23 to 25, comprising combining the lipid binding protein-based complex and the one or more components of an organ preservation solution.

27. A process for preparing an organ preservation solution comprising combining a lipid binding protein-based complex and one or more components of an organ preservation solution, optionally wherein the lipid binding protein-based complex is as defined in any one of claims 1 to 8.

28. The process of claim 27, wherein the one or more components of an organ preservation solution comprise a buffer, an antioxidant, a nutrient and/or metabolic substrate, an electrolyte, a colloid, an impermeant, a gas, or a combination thereof.

29. An organ preservation solution produced by the process of any one of claims 26 to 28.

30. An organ preservation solution product comprising the organ preservation solution of any one of claims 9 to 21 and 29 in a sealed container.

31. The organ preservation solution product of claim 30, wherein the container is a bag.

32. The organ preservation solution product of claim 30 or claim 31, wherein the container comprises 1 L of the organ preservation solution.

33. A system comprising (a) the organ preservation solution of any one of claims 9 to 21 and 29 or the organ preservation solution product of any one of claims 30 to 32 and (b) a perfusion machine and/or an organ.

34. The system of claim 33, which comprises a perfusion machine.

35. The system of claim 34, wherein the perfusion machine is a heart-lung machine.

36. The system of any one of claims 33 to 35, which comprises an organ.

37. The system of claim 36, wherein the organ is a kidney, a liver, a heart, a lung, pancreas, intestine, or trachea.

38. The system of claim 37, wherein the organ is a kidney.

39. The system of any one of claims 33 to 38, wherein the organ is from a mammal, optionally a human or pig.

40. A process for ex-vivo organ preservation, comprising contacting a donor organ with the organ preservation solution of any one of claims 9 to 21 and 29.

41. The process of claim 40, which comprises subjecting the organ to machine perfusion with the organ preservation solution, optionally for at least one hour and/or up to 1 week.

42. The process of claim 40, which comprises cold storage of the organ in the absence of machine perfusion, optionally at 2° C. to 6° C.

43. The process of any one of claims 40 to 42, wherein the organ is a kidney, a liver, a heart, a lung, pancreas, intestine, or trachea.

44. The process of claim 43, wherein the organ is a kidney.

45. The process of any one of claims 40 to 44, wherein the organ is from a mammal, optionally a human or pig.

46. An organ obtained by the process of any one of claims 40 to 45.

47. A method for transplanting an organ, comprising transplanting the organ of claim 46 into a subject in need thereof.

48. A process for ex-vivo tissue preservation, comprising contacting a donor tissue with the organ preservation solution of any one of claims 9 to 21 and 29, optionally wherein the donor tissue is stored in the organ preservation solution for at least 1 hour and/or up to 4 weeks.

49. The process of claim 48, wherein the tissue is eye, skin, fat, muscle, bone, cartilage, fetal thymus, or nerve tissue.

50. The process of claim 49, wherein the tissue is cornea tissue.

51. A tissue obtained by the process of any one of claims 48 to 50.

52. A method for transplanting a tissue, comprising transplanting the tissue of claim 51 to a subject in need thereof.

53. A transplantation method comprising:
a. obtaining a donor organ;
b. contacting the donor organ with the organ preservation solution of any one of claims 9 to 21 and 29, wherein the contacting comprises:
i. machine perfusion of the organ with the organ preservation solution; or
ii. cold storage of the organ in the organ preservation solution; and
c. transplanting the organ into a subject in need of an organ transplant.

54. The method of claim 53, wherein the donor organ is a kidney, a liver, a heart, a lung, pancreas, intestine, or trachea.

55. The method of claim 53 or claim 54, wherein the contacting comprises machine perfusion or cold storage of the organ with the organ preservation solution for at least one hour and/or up to 1 week.

56. A transplantation method comprising:
a. obtaining a donor tissue;
b. storing the donor tissue in the organ preservation solution of any one of claims 9 to 21 and 29, and
c. transplanting the tissue to a subject in need of a tissue transplant.

57. The method of claim 56, wherein the donor tissue is eye, skin, fat, muscle, bone, cartilage, fetal thymus, or nerve tissue.

58. The method of claim 56 or claim 57, wherein the storing comprises storing the tissue with the organ preservation solution for at least one hour and/or up to 4 weeks.


SEQUENCE LISTING (2 sequences)

SEQ ID NO: 1 - protein, 190 aa, Artificial Sequence
  ApoA-I
PPQSPWDRVKDLATVYVDVLKDSGRDYVSQFEGSALGKQLNLKLLDNWDSVTSTFSKLREQLGPVTQEFWDNLEKETEGLRQEMSKDLEEVKAKVQPYLDDFQKKWQEEMELYRQKVEPLRAELQEGARQKLHELQEKLSPLGEEMRDRARAHVDALRTHLAPYSDELRQRLAARLEALKENGGARLAEY

SEQ ID NO: 2 - protein, 267 aa, Homo sapiens
MKAAVLTLAVLFLTGSQARHFWQQDEPPQSPWDRVKDLATVYVDVLKDSGRDYVSQFEGSALGKQLNLKLLDNWDSVTSTFSKLREQLGPVTQEFWDNLEKETEGLRQEMSKDLEEVKAKVQPYLDDFQKKWQEEMELYRQKVEPLRAELQEGARQKLHELQEKLSPLGEEMRDRARAHVDALRTHLAPYSDELRQRLAARLEALKENGGARLAEYHAKATEHLSTLSEKAKPALEDLRQGLLPVLESFKVSFLSALEEYTKKLNTQ